(19) United States
(12) Patent Application Publication
(10) Pub. No.: US 2006/0062870 A1
(43) Pub. Date: Mar. 23, 2006

(54) System and apparatus for forming product from thermoplastic material utilizing a vertical forming tunnel

(75) Inventors: David L. Cyphert, Canal Winchester, OH (US); John S. Berns, Cleveland, TN (US); Harold M. Minderman, Cleveland, TN (US); George A. Cantrell, Corryton, TN (US)

Correspondence Address: Gerald L. Smith;Mueller and Smith, LPA, 7700 Rivers Edge Drive, Columbus, OH, 43235, US

(73) Assignee: Modem Machine Corporation

(21) Appl. No.: 11/152,760

(22) Filed: Jun. 14, 2005

Related U.S. Application Data
(60) Provisional application No. 60/610,738, filed on Sep. 17, 2004.

(51) Int. Cl. B29C 47/20

(52) U.S. Cl. 425/326.1

(57) ABSTRACT

System and apparatus for carrying out a thermoplastic material molding process wherein mutually abutting carriage conveyed clamshell molds are driven along a single track locus having vertically disposed tunnel forming and return region. Thermoplastic material is expressed vertically downwardly from a die nozzle located above the forming tunnel entrance elevation and with a diameter corresponding with but slightly less than the maximum diametric extent of a mold cavity within the mold sequence. Where a given mold cavity portion exhibits a minimum or zero cross dimension, the mold cavity is structured having an adjacent accommodation mold cavity portion of greater cross dimension.

### CROSS-REFERENCE TO RELATED APPLICATIONS

This application claims priority to provisional application 60/610,738 filed Sep. 17, 2004.

### STATEMENT REGARDING FEDERALLY SPONSORED RESEARCH

Not applicable.

### BACKGROUND OF THE INVENTION

Formation of smaller molded piece parts such as bottles which are intended to be filled to retain liquid and other chemicals such as household cleaning products, food products and a variety of other comestibles and distributed on the scale of billions of items per year, generally has called for very large, somewhat centralized hard-tooled blow molding installations. These molding installations, for example, may produce two to three bottles or similar items per second. Those plastic containers are then shipped from the somewhat central or regional location of their production to the filling facilities of producers of products calling for disposable containers. Such a shipment involves the relatively costly movement of very light but highly bulksome containers.

Blow molding systems of lesser production capabilities, size and cost have been employed for utilization in closer proximity to industries requiring a lower thermoplastic product volume. With such an arrangement, thermoplastic raw materials, as opposed to empty containers are shipped to the on-site molding location. Such local installations typically will produce at piece part levels from about one million per year to several million per year. For instance, localized facilities may produce such products as boot protectors for under-frame automotive components.

These relatively smaller local blow molding facilities are somewhat limited, however, as a consequence of the characteristics of the basic blow molding process. That process typically provides two relatively large, water or glycol cooled mold blocks which may have three or four vertically disposed cavities and when conjoined, are closed at the bottom to define a container bottom surface. A die is provided which extrudes an open cylindrically shaped shot of heated thermoplastic material well into the resultant mold cavity, for instance, the shot may be extruded downwardly to an extent of two-thirds to three-fourths of the entire length of the formed mold cavity. Such a vertical disposition of the extruded thermoplastic material, without more, evokes a gravitationally induced droop or thinning sag at the upper reaches of the freely hanging extrudate. This gravitationally induced upper material wall thinning has been accommodated for by extruding more material in the later portion of the extrudation process. Expanded material flow may be accomplished, for example, by adjusting the die gap to achieve more wall gage in the product upper region. When the freely suspended extrudate has descended to the proper depth within the mold cavity, extrudation is halted and air under pressure is injected within the interior of the extrudate mass to force the hot plastic material against the forming walls of the mold cavity. The process must then stop or dwell as a cooling cycle ensues and the die blocks are liquid cooled. Such a cooling cycle may require, for instance, a twenty-five second to thirty second cooling interval. As is apparent, this localized approach, while at times practical, exhibits inherit limits in piecepart production capacity.

Another thermoplastic molding approach employed by local production entities has been to carry out a continuous procedure with a sequence of horizontially disposed vacuum activated mold pairs. One sequence of mold halves are mounted on a continuous lower horizontal track located about spaced-apart lower sprockets or the like. The oppositely disposed sequence of half-molds of the mold pairs are mounted on a continuous upper horizontal track located about spaced apart upper sprockets or the like. By synchronizing the travel of the upper and lower tracks, the pairing mold halves form a dynamic, continuous mold chamber. A thermoplastic material is continuously extruded into this chamber to be drawn by applied vacuum toward the walls of the mated mold halves. Material cooling is carried out as the mold half pairs are moved toward the exit location of the process. Corrugated plastic pipe of relatively smaller diameter is a typical product of this process. The process continuity achieved is an advantageous aspect of this procedure. However, maintaining a registry of the mold halves of each mold pair as it is maneuvered through the process is problematic.

A continuous production system approach to overcoming the noted registration difficulties has been to utilize a single supported track extending horizontially between spaced-apart sprockets or the like in combination with what has been referred to as a sequence of “clamshell” molds. These molds are configured with track-mounted clamshell carriages having mechanically synchronized, mutually outwardly and inwardly pivoting support wings. These wings are configured for carrying or mounting paired die halves. As the continuous track maneuvers the carriage-mounted vacuum actuated mold halves toward a resultant dynamic mold tunnel entrance, the carriage wings are pivoted mutually inwardly by cam action to close the mold halves together with essentially assured registry. This process also is generally utilized for the formation of corrugated drainage pipe of lesser diametric extent.

A variety of industries now are seeking thermoplastic molding installations for local or moderate production scale uses which have a capability for efficiently producing a broadened variety of products, for example, having closed-end features such as bottles and the like heretofore the province of blow molding systems.

### BRIEF SUMMARY OF THE INVENTION

The present invention is addressed to system and apparatus for carrying out a thermoplastic material molding process wherein mutually abutting carriage conveyed clamshell configured molds are driven along a single track locus having vertically disposed tunnel forming and return regions. As pivotally coupled mold halves are moved along an uppermost transition region toward the vertical tunnel forming region they are pivotally maneuvered toward a closed mold orientation which orientation is completed at the entrance elevation of a downwardly moving mold defining forming tunnel. Thermoplastic material is expressed vertically downwardly from an annulus-shaped die nozzle located vertically above the tunnel entrance elevation such that the molds close upon the gravitationally descending extrudate. When within the dynamically descending forming tunnel region, vacuum is applied to the molds to draw the extrudate into the mold cavities. In this regard, one or more of the closed mold cavities will exhibit a cavity portion of maximum diametric extent or cross dimension. The die nozzle diameter will be dimensioned to correspond with but be slightly less than that cavity diametric extent or cross dimension to minimize the stretch ratio asserted by vacuum upon the extrudate as it is drawn into the mold cavities. Conversely, where a given mold cavity exhibits a mold cavity portion of zero to a minimum diametric extent or cross dimension substantially less than the mold cavity portion of maximum diametric extent or cross dimension then a next adjacent mold cavity component is configured as an accommodation mold cavity portion with an accommodation diametric extent or cross dimension much greater than the zero to minimum diametric extent or cross dimension. That accommodation mold cavity portion will be positioned above and next adjacent the mold cavity of zero to minimum diametric extent or cross dimension.

To accommodate the vacuum forming technique associated with the forming tunnel region, make-up gas or air under low pressure is asserted from the center of the die nozzle in conjunction with an upwardly extending open tube functioning to ameliorate air pressure surges which may be occasioned in the course of product cut-off at the system outfeed or where closed end products are being formed.

Another feature and object of the invention is to provide the carriage conveyed clam shell configured molds, as driven along the single track locus, with two or more mold cavities. This feature is available in consequence of the inherent configuration flexibility and robust structure of the molding apparatus. By employing two or more mold cavities, the molded product through-put rate is advanced with only minor penalty. That penalty may be evoked as a slightly slower drive rate to achieve cooling of what may be a larger quantity of thermoplastic material within multiple, vertical forming tunnels.

Other objects of the invention will, in part, be obvious and will, in part, appear hereinafter.

The invention, accordingly, comprises the apparatus and system possessing the construction, combination of elements and arrangement of parts which are exemplified in the following detailed description.

For a fuller understanding of the nature and objects of the invention, reference should be made to the following detailed description taken in connection with the accompanying drawings.

### BRIEF DESCRIPTION OF THE DRAWINGS

FIG. 1 is a top view of a molding system according to the invention;

FIG. 2 is a front view of the molding system of FIG. 1;

FIG. 3 is a right side view of the molding system of FIG. 1;

FIG. 4 is a partial view of the molding system shown in FIG. 2;

FIG. 5 is a partial left side view of the molding system of FIG. 1;

FIG. 6 is a partial top view of the molding system of FIG. 1;

FIG. 7 is a partial sectional side view of a mold array employed with the system of FIG. 1;

FIG. 8 is a perspective and exploded view of a mold and carriage assembly employed with the system of FIG. 1;

FIG. 9 is a sectional view taken through the plane 9-9 shown in FIG. 7;

FIG. 10 is a perspective view of a track assembly employed with the molding system of FIG. 1;

FIG. 11 is a partial perspective view of the die and upper transition region of the molding system of FIG. 1;

FIG. 12 is a sectional view taken through the plane 12-12 shown in FIG. 11;

FIG. 13 is a sectional view taken through the plane 13-13 shown in FIG. 11;

FIG. 14 is a bottom view of a half mold employed with a molding system of the invention;

FIG. 15 is a side view of the half mold of FIG. 14;

FIG. 16 is a front view of a mold formed part prior to trimming;

FIG. 17 is a front view of the part of FIG. 16 following a trimming procedure;

FIG. 18 is a top view of a molding system according to the invention showing extrudate feed to a mold and carriage assembly incorporating three mold cavities;

FIG. 19 is a front view of the molding system of FIG. 18;

FIG. 20 is a sectional view similar to FIG. 12 but illustrating a mold and carriage assembly structure with three mold cavities;

FIG. 21 is a sectional view similar to FIG. 13 but illustrating a mold and carriage assembly configuration incorporating three mold cavities;

FIG. 22 is a bottom view of a half mold employed with a molding system of the invention;

FIG. 23 is a side view of the half mold of FIG. 22; and

FIG. 24 is a top view of a mold assembly incorporating two mold cavities having generally rectangular cross-sectional configurations.

### DETAILED DESCRIPTION OF THE INVENTION

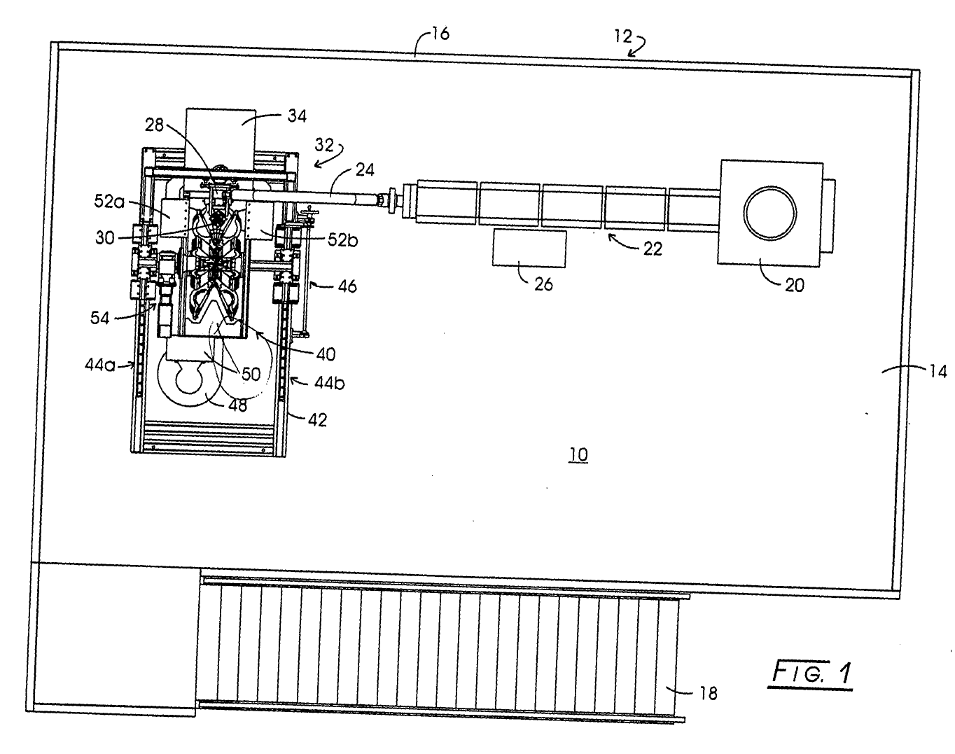

The molding apparatus to be described is characterized in the utilization of dual mold half carrying carriages which manipulate the molds in clam shell fashion as well as the utilization of a track assembly carrying the molds which causes them to create a dynamic forming tunnel which is vertical. Thermoplastic material is expressed from a nozzle annulus at a location positioned above the commencement of this dynamic mold created vertical forming tunnel. To achieve this verticality, the system may be implemented with a platform assembly having an upper floor located well above the floor of a manufacturing facility. Looking to FIG. 1, the molding system, represented in general at 10, is illustrated looking down upon a platform represented generally at 12 which supports an elevated floor 14 surmounted by a peripherally disposed railing 16. Access to the floor 14 is by a stairway 18.

Seen mounted on the floor 14 is a feed hopper 20 which is loaded with typically pelletized thermoplastic material for introduction to an elongate, screw activated extruder or heater and pressurization assembly represented generally at 22. Within the extruder 22, the thermoplastic material is heated and conveyed under pressure to a distribution tube 24. A plurality of heater bands (not shown) are positioned over the distribution tube 24 to maintain the elasticity of the material being driven through it. Sitting adjacent the extruder 22 is a housing or box 26 functioning to retain electrical control equipment.

Distribution tube 24 extends in material conveying relationship to a die distribution manifold 28 which, in turn, is coupled in material distribution relationship with a die 30. The combination of die manifold 28 and die 30 will be seen to be vertically adjustable and supported from a die support frame represented generally at 32. An angularly downwardly depending flat shield member is shown at 34 extending outwardly from the die support frame 32. Extruder die 30 performs in conjunction with a molding assembly represented generally at 40 which extends from a location above the floor 14 of support assembly 12 downwardly through a rectangular opening 42 within the floor 14. Molding assembly 40 is mounted upon a track and carriage system, the upper components of which are seen in the figure at 44a and 44b. This track and carriage system functions to permit the relative movement of the molding assembly 40 with respect to the die 30 for purposes of reconfiguring the molds or maintenance. This movement is carried out by manipulation of an elongate crank and screw assembly represented generally at 46. The molding assembly 40 incorporates a track assembly which, in turn, supports and provides manipulation of a plurality of carriages which, in turn, carry mateing mold halves in a manner permitting clam shell performance. Additionally mounted with and moveable with the assembly 40 are cooling duct components and associated blowers. In this regard, an air blower is observable at 48 which is located below the level of floor 14 and feeds a generally V-shaped duct 50. A similar blower arrangement, duct components which are seen at 52a and 52b, functions to carry out cooling of the closed molds along a dynamic vertically oriented forming tunnel. A drive assembly incorporating an electric motor and an associated reduction gear box is represented generally at 54 mounted and moveable with assembly 40.

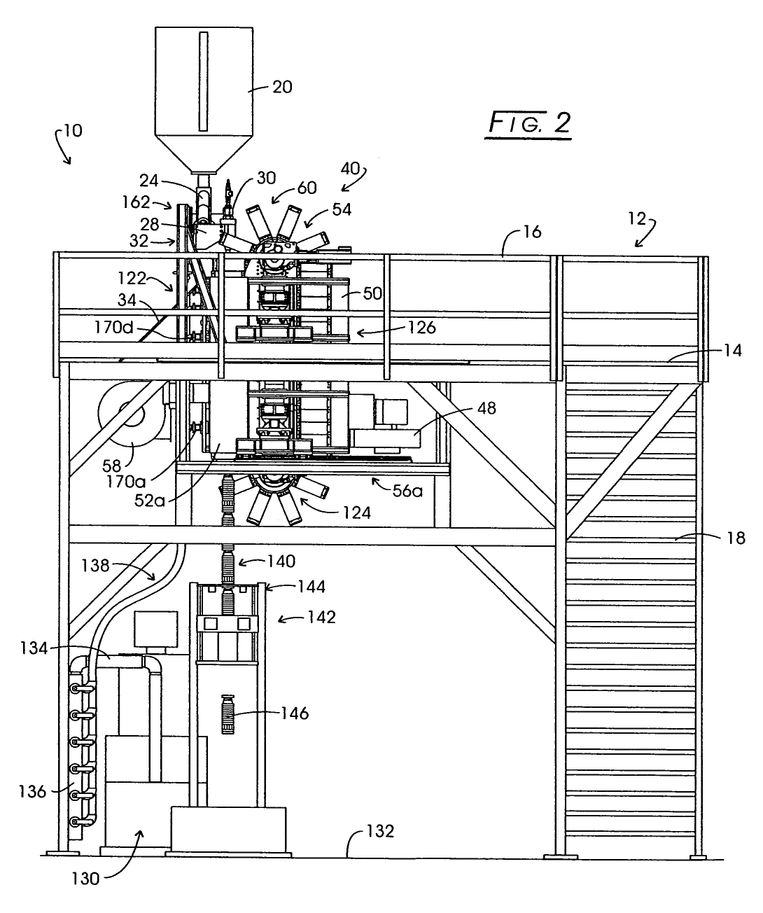

Looking to FIG. 2, a front view of the system 10 is revealed. The figure shows one lower component, 56a of the track and carriage system supporting molding assembly 40. Also located below the floor level 14 is an air blower 58 which is moveable with the molding assembly 40 and which functions to feed cooling air to ducts 52a and 52b, duct 52a being seen in the instant figure. In general, the molding assembly 40 incorporates a track assembly which is not seen in this figure but which supports a plurality of mutually abutting carriages in a capture fashion which in turn, support paired clam shell configured mold halves. Movement of the molds is along a single track locus. The track assembly has an upper transition region with an upper introduction portion which is located as generally represented at 60. Introduction portion 60 transitions downwardly toward the entrance of a substantially vertical forming tunnel region with a forming tunnel support portion 122. Paired molds at tunnel location 122 are cooled by the air ducts 52a and 52b. That forming tunnel region extends to an outfeed transition region 124 with an outfeed portion. From region 124 the track assembly supports open clam shell die halves as they are vertically driven upwardly at a vertical return region with a return track assembly portion represented generally at 126. That return region extends to the upper transition region at 60. As the closed die halves extend and move along the forming tunnel region 122 they slidably engage a vertical sequence of six vacuum stages. In this regard, the figure reveals a vacuum pump assembly represented generally at 130 and located on the manufacturing floor represented at level 132. Floor 132 also supports the platform 12. Pump assembly 130 provides vacuum via conduit 134 to a vacuum distribution manifold 136 which supplies six discrete vacuum conditions via a flexible hose array represented generally at 138. As the mold halves leave the dynamic forming tunnel described generally at region 122 they are opened to release, a continuous typically interconnected sequence of plastic products as represented generally at 140. That interconnected line of products then is subjected to a guillotine type cutting assembly represented generally at 142 which performs in conjunction with a product position sensing component represented generally at 144. The severed products as seen at 146 then are conveyed to a trimming station for completion.

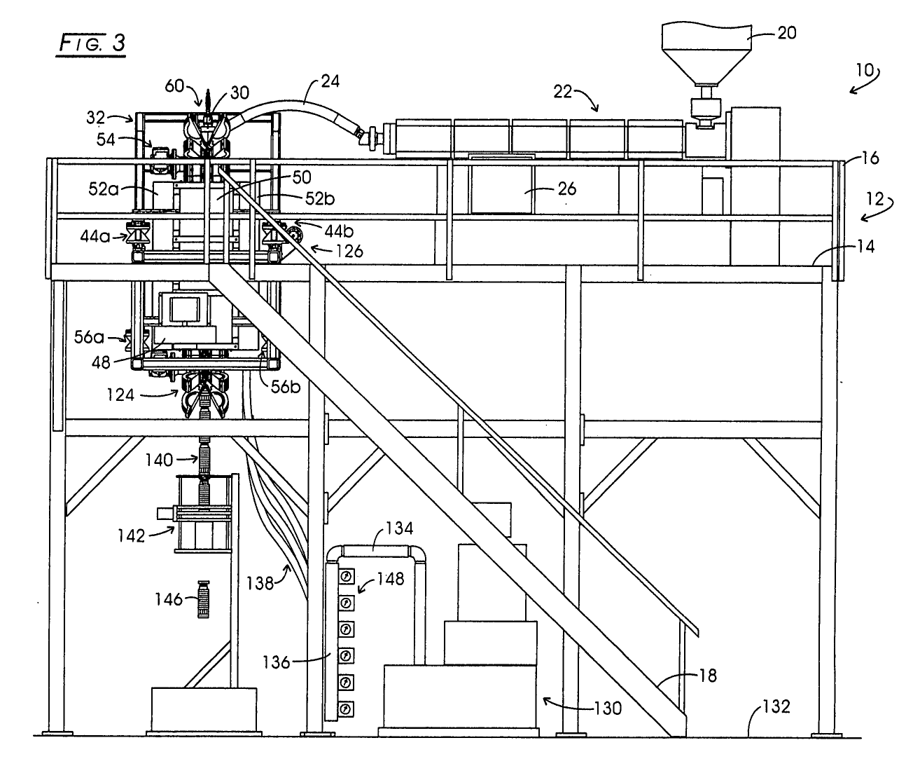

Looking additionally to FIG. 3, vacuum manifold 136 is seen to incorporate an array of vacuum gauges represented generally at 148. Three of the six vacuum hoses of array 138 are observed. Additionally, the lower components 56a and 56b of the track and carriage assembly supporting mold assembly 40 are revealed. Note in the figure at the outfeed region 124 the clamshell mounted mold halves are open. The mold halves remain open until reaching the upper transition region 60 at the top of the assemblage. As the open mold halves move upwardly along the return region 126 they are cooled by the generally V-shaped air ducting 50 associated with blower 48.

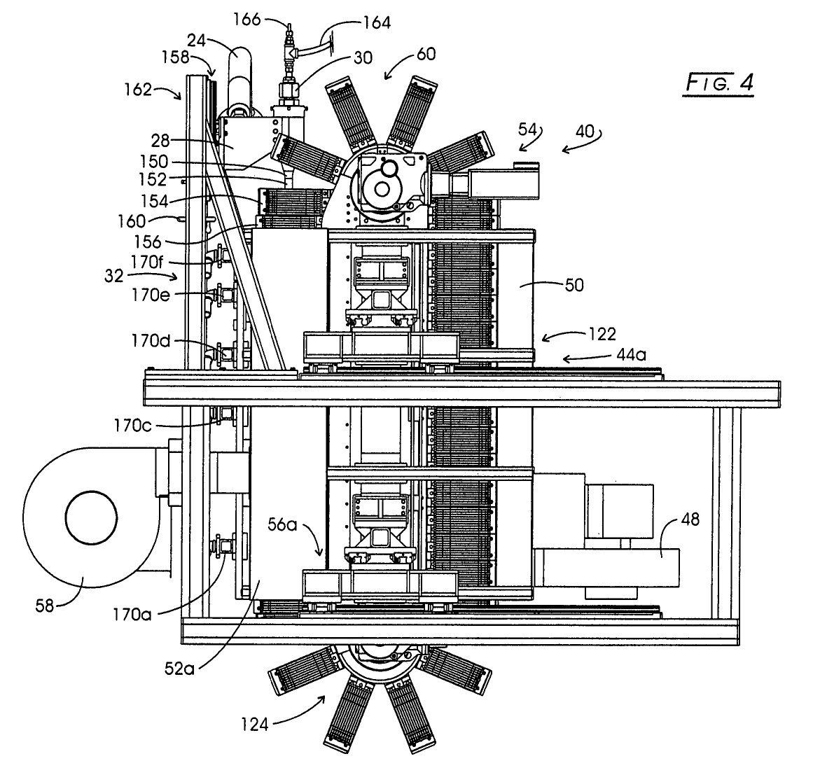

Turning to FIG. 4, an enlarged front view of the molding assembly 40 is revealed. In the figure, the outwardly extending cooling fins of the mold halves are shown and at the introduction or upper transition region 60 mold halves are seen extending about die 30. In this regard, the die 30 extends downwardly to an annulus-shaped die nozzle 150 from which a generally cylindrically-shaped thermoplastic extrudate, sometimes referred to as a parison, issues as at 152. The mold pair incorporating mold half 154 is seen in the process of closing about extrudate 152 just before the commencement of the forming tunnel. The commencement of that forming tunnel is shown at the elevation 156. Die 130 is adjustable vertically by virtue of the connection of manifold 28 with a screw assemblage represented generally at 158 incorporating a hand crank 160. Mounting is upon a stationary die support represented generally at 162 and formed of an assemblage of box beams. Make-up air is supplied via an air hose 164 to the center of the die 30. This air supply is of very low pressure (about 3 psi to about 5 psi) and any back pressure is accommodated for by a small opening within an upwardly disposed tube 166. Such back pressure events may be witnessed, for instance, upon the actuation of guillotine cutting assembly 142 (FIG. 2) or during the formation of closed-end products. The make-up air tends to widen the extrudate 152 as it emerges from the annulus-shaped nozzle 150. The figure also reveals five of a sequence of six cross supports 170a and 170c-170f which are attached to the molding assembly 40 and support vacuum inputs to a vertically disposed six compartment vacuum manifold.

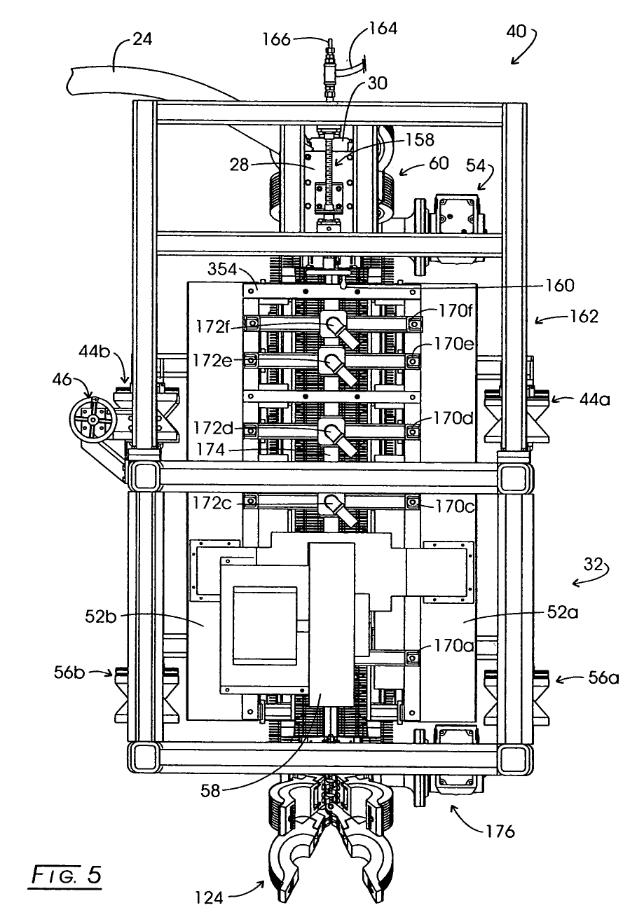

Looking to FIG. 5, an enlarged left side view of the assembly 40 and support frame 32 is revealed. Cross supports 170a and 170c-170f reappear and are seen to support vacuum elbow inputs certain of which are shown at 172c-172f. Those inputs extend to a vertically disposed six-compartment vacuum manifold represented generally at 174. These elbow connectors are associated with the flexible vacuum hose array represented generally at 138 in FIG. 2. The figure further illustrates the die 30 vertical adjustment screw assembly 158 and associated crank 160. Note the presence of an idling reduction gear assembly shown generally at 176. No motor drive is applied to assembly 176.

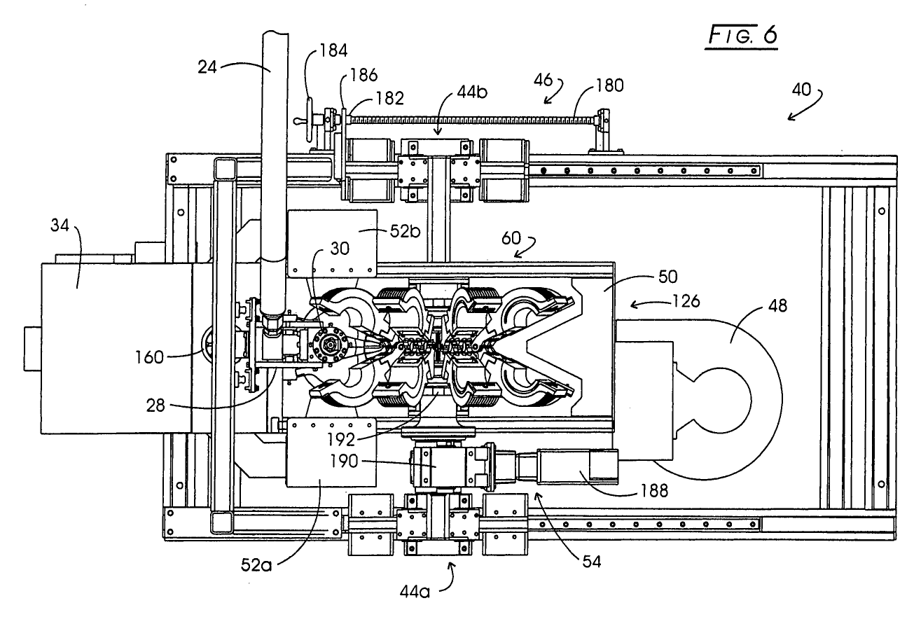

Referring to FIG. 6, an enlarged top view of the molding assemblage 40 and the die assembly is provided. In the figure, the opened clam shell connected mold halves are seen emerging from the return region 126, the interior cavities of the molds having been cooled by air from blower 48 via V-shaped duct 50. As the molds move about the upper transition region 60 they move about the die 30 toward the commencement of the forming tunnel. In the figure, crank and screw assembly 46 is revealed in more detail incorporating an endless screw component 180, a follower nut 182 and a crank 184. Nut 182 is coupled with the upper component 44b of the track and carriage system via a bracket 186. Additionally, the figure reveals the drive assembly 54 to comprise an electric motor 188 and a reduction gear box 190. The output of gearbox 190 will be seen to drive an upper sprocket associated with a track assembly. In this regard, an output shaft from the gear reduction assembly 190 is shown at 192.

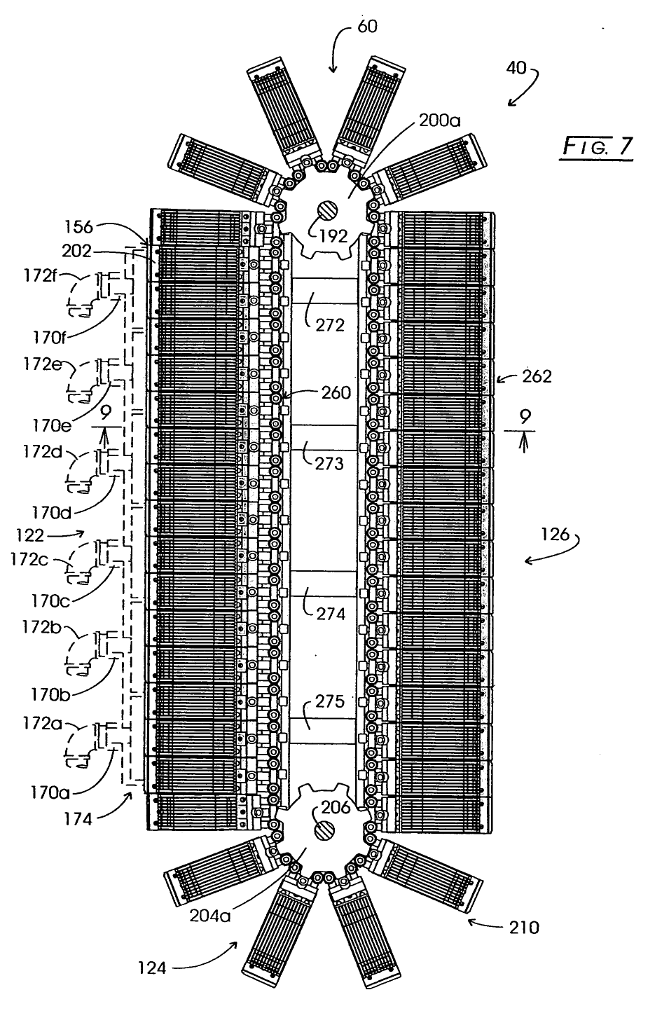

Looking to FIG. 7, output shaft 192 of drive assembly 54 reappears in driving relationship with an upper front side drive sprocket 200a. This drive assembly performs in conjunction with a track assembly which captures the mold carriage components of paired mold halves and effects their opening and closing. Commencement of the dynamic forming tunnel again is identified at level 156 and it may be observed that below that level molds will encounter the six compartments of the vacuum manifold 174. The carriages supporting the mold pairs are configured with rollers and are not interconnected. Sprockets as at 200a drivably move the carriage and mold combinations over upper transition region 60 into the forming tunnel region 122. That mold located below the entrance to the forming tunnel, for example, as at location 202 will be seen to be in vacuum transfer contact with the upper compartment of the vertical vacuum manifold 174. As the carriages and associated molds exit from the forming tunnel region 122 they will encounter lower paired sprockets, one of which is revealed at 204a mounted upon a lower shaft 206 which is coupled to the reduction gear assemblage 176 described in connection with FIG. 5. As noted above, there is no motor drive asserted upon the shaft 206. However, by virtue of the connection of shaft 206 with a gear train, a form of drag is imposed on the conveyance system. As the forming tunnel is terminated and the product string 140 emerges as illustrated in FIGS. 2 and 3, the sprocket pair including that at 204a move the carriages and mold pairs from the outfeed transition region 124 into the return region 126. The isolated view of FIG. 7 reveals that the inwardly disposed carriage components for each of the clamshell configured mold half pairs incorporate rollers. These rollers will be seen to function as a race captured mold pair carrier as transport rollers and for purposes of cam following activity functioning to open and close the molds. Further, the devices incorporate a stabilizing roller pair assuring appropriate alignment within the forming tunnel region 122.

Looking to FIG. 8, a mold carriage and associated mold half pair are revealed in perspective and exploded fashion in general at 210. The mold carriage is represented in general at 212 and is configured with a somewhat rectangular steel mold carriage base 214 having four inwardly disposed freely rotatable steel transport rollers 216a-216d of given diameter. Outboard of the transport rollers 216a-216d are polymeric carriage race engagement rollers shown respectively at 218a-218d. Follower rollers 218a-218d are of slightly smaller diameter than the given diameter of transport rollers 216a-216d.

Integrally formed with and extending upwardly from the mold carriage base 214 are two aligned and spaced apart hinge ears 220a and 220b which are configured to receive a hinge shaft or pin 222. Pin 222 is retained in position by locking pin 224. This hinge arrangement is utilized in conjunction with oppositely disposed carriage wings 226a and 226b. Wing 226a is configured with two aperture hinge ears 228a and 228b which are hingedly engaged with the shaft 222 and associated carriage ears 220a and 220b. Wing 226a further is configured to define a mold half mount represented generally at 230 and extending outwardly from it is a polymeric carriage follower roller 232 which follows a track assembly cam to pivot the wing 226a between mold open and mold closed orientations.

Carriage wing 226b is configured in compliment with that at 226a. In this regard, the wing 226b is configured with two aperture hinge ears 234a and 234b, only the former being visible in the figure structured to engage the shaft 222 and pivot thereabout. Integrally formed with and oppositely disposed from the ears 234a and 234b is a mold half mount represented generally at 236. Extending outwardly from the wing 226b is a polymeric carriage follower roller 238 which performs in concert with follower roller 232 to provide synchronized pivoting about shaft 222. Three hinge completing bearing spacers are represented generally at 240 which cooperate with hinge ears 228a, 228b, 234a and 234b. The mold component associated with mold carriage 212 is represented generally at 242 and comprises two mold halves, 244a and 244b. These mold halves are configured with respective mounting portions 246a and 246b which are secured to respective carriage mounts 230 and 236. With that arrangement, the system 10 may be reconfigured with relative ease. Outer surfaces 248a and 248b of respective molds halves 244a and 244b are configured with fins to enhance heat removal in conjunction with the earlier-described blower 58 and its associated ducts 52a and 52b. The outwardly disposed regions of the mold halves 244a and 244b are configured with outwardly disposed protrusions 250a and 250b which are configured to define a slot-shaped vacuum input port 252 when the mold halves 244a and 244b are joined together as illustrated. Port 252 is seen to extend to arcuate vacuum distribution slots 254a and 254b. In general, when the mold 210 is closed the protrusions 250a and 250b slide along the vacuum manifold 174, for example, as described in connection with FIG. 7.

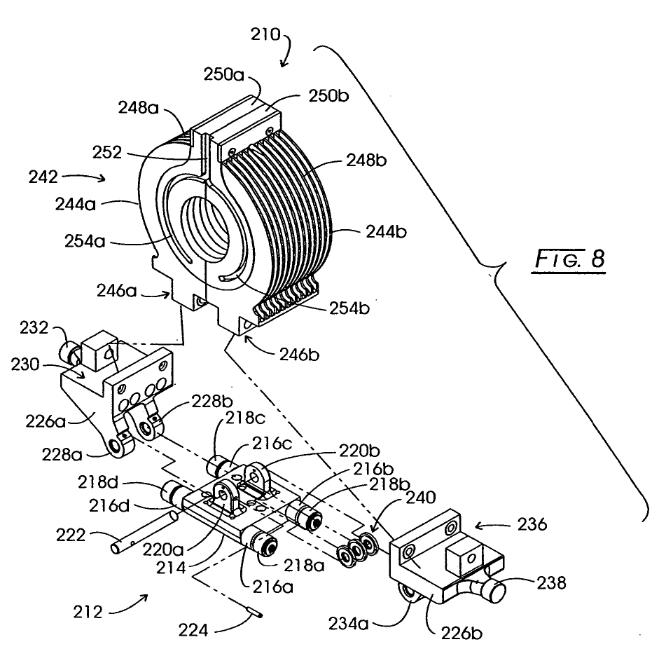

FIG. 9 is a sectional view taken from FIG. 7 showing in partial sectional fashion two mold and carriage assemblies 260 and 262 as they are performing in conjunction with a track assembly. Mold and carriage assembly 260 is located within the tunnel forming region 122, while mold and carriage assembly 262 is located within the return region 126. For convenience, components of these molding carriage assemblies described in connection with FIG. 8 are identified with the same numeration but in prime and double prime fashion. Mold and carriage assembly 260 is shown as it is located within the vertical tunnel forming region 122 containing a corresponding track assembly forming tunnel support portion represented generally at 264. Track assembly portion 264 is shown having oppositely disposed capture channels or races 266a and 266b within which respective polymeric race engagement rollers 218a′ and 218d′ are rotatably engaged. Carriage 212′ is shown stabilized by two spaced apart polymeric rollers 268a and 268b which rotationally engage the forming tunnel portion of a stabilizer bar represented generally at 270. Capture channels 266a and 266b as well as stabilizer bar 270 are attached within the track assembly to four track assembly brackets identified in FIG. 7 at 272-275. Bracket 272 is revealed in the instant figure. Note that mold and carriage assembly 260 is in a closed orientation. This orientation is present inasmuch as carriage follower rollers 232′ and 238′ are engaged in rolling relationship with respective forming tunnel region cam bars 280 and 282. This closed orientation of the mold halves 244a′ and 244b′ permits the definition of the vacuum input port 252′. Note, additionally, as shown in phantom that the exterior finned surfaces of the mold halves 244a′ and 244b′ are being cooled by air issuing from the vertical ducts 52b and 52a.

Mold and carriage assembly 262 is shown located within the return region 126. Thus, it is being maneuvered along the track assembly return portion represented generally at 284 which incorporates spaced apart and mutually inwardly facing capture channels or races 286a and 286b. As before, these races engage respective race engagement rollers 218a″ and 218d″. Mold carriage 212″ is stabilized by inwardly depending polymeric rollers 288a and 288b which straddle the stabilizer bar 270. The return region incorporates spaced apart cam defining return portions of the track assembly as seen at 290 and 292. In this regard, portion 290 incorporates a cam capture channel 294 of rectangular cross section which engages corresponding carriage follower roller 232″ in an orientation providing for a pivoting of mold half 244a″ about hinge shaft 222″ to an open condition. In similar fashion, track assembly return portion 292 is configured with a cam capture channel 296 of rectangular cross section which engages carriage follower roller 238″ to effect the pivoting of wing 226b″ about hinge shaft 222″ to orient mold half 244b″ in an open orientation. Note that as the open molds are maneuvered along the return region 126 the interior cavity portions of the mold halves as at 244a″ and 244b″ as shown respectively at 298a and 298b are air cooled by blown air issuing from the vertical duct 50.

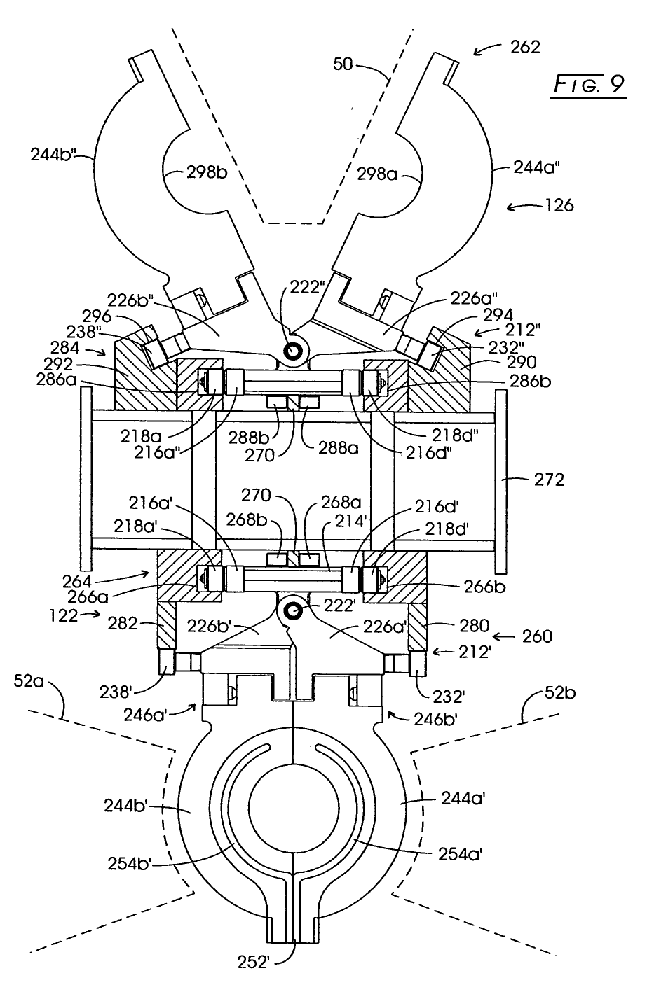

Turning to FIG. 10 the noted track assembly is revealed in perspective fashion in general at 300 in combination with a single mold and carriage assembly 260 which is carried over from FIG. 9. Accordingly, the same identifying numeration is employed with it. Note that carriage follower rollers 232′ and 238′ are in rolling engagement with respective cam bars 280 and 282 to provide for a closed orientation of the mold halves 244a′ and 244b′. Note, additionally, that race engagement roller 218c′ is engaged within capture channel 266b. As is indicated in FIGS. 9 and 10, transport rollers 216a-216d do not engage the track assembly 300. In this regard, these transport rollers freely abuttably engage the corresponding adjacent transport rollers of a next adjacent carriage assembly in the sequence of carriage assemblies and associated paired half molds. The carriage and mold assemblies are not interconnected and are operationally associated by this transport roller mutual abutment. As the carriage and mold assemblies move through the tunnel forming region 122 they will enter the outfeed transition region 124. Within this region, the track assembly 300 includes an outfeed portion represented generally at 310 which incorporates mutually inwardly facing and spaced apart outfeed transition channels, as revealed at 312 and 314. Transition channels as at 312 and 314 engage the race engagement rollers described in connection with FIG. 8 at 218a-218d to support the carriage assemblies as they are driven about lower sprockets as described at 204a in FIG. 7. During this maneuver carriage follower rollers as described at 232 and 238 in connection with FIG. 8 are engaged within mutually inwardly facing and spaced apart lower transition cam capture channels as seen in FIG. 10 at 316 and 318. Note that channels 316 and 318 are configured so as to pivotally maneuver the wings as described at 226a and 226b in FIG. 8 to an open mold orientation. As noted in connection with FIG. 9, that open mold orientation continues as the sequence of molds transition through the return region 126, the open orientation permitting a cooling of the interior cavities as described at 298a and 298b in FIG. 9. Upon moving through the return region 126, the molds will encounter the upper transition region 60. The track assembly 300 is configured with an uppermost introduction portion represented generally at 320. Portion 320 is configured having mutually inwardly facing and spaced apart upper introduction transition channels, as shown at 322 and 324. Channels 322 and 324 are configured to engage the race engagement rollers as described at 218a-218d in connection with FIG. 8 as the associated carriages are moved through region 60. Within region 60, additionally, the track assembly 300 introduction portion 320 is configured having mutually inwardly facing and spaced apart upper transition cam capture channels 326 and 328. Channels 326 and 328 are configured to engage respective carriage follower rollers 232 and 238 as described in connection with FIG. 8 and cause the associated wings 226a and 226b to pivot about a hinge shaft 222 to close the corresponding mold halves 244a and 244b. Complete closure is realized as those cam rollers engage the vertical cam bars 280 and 282.

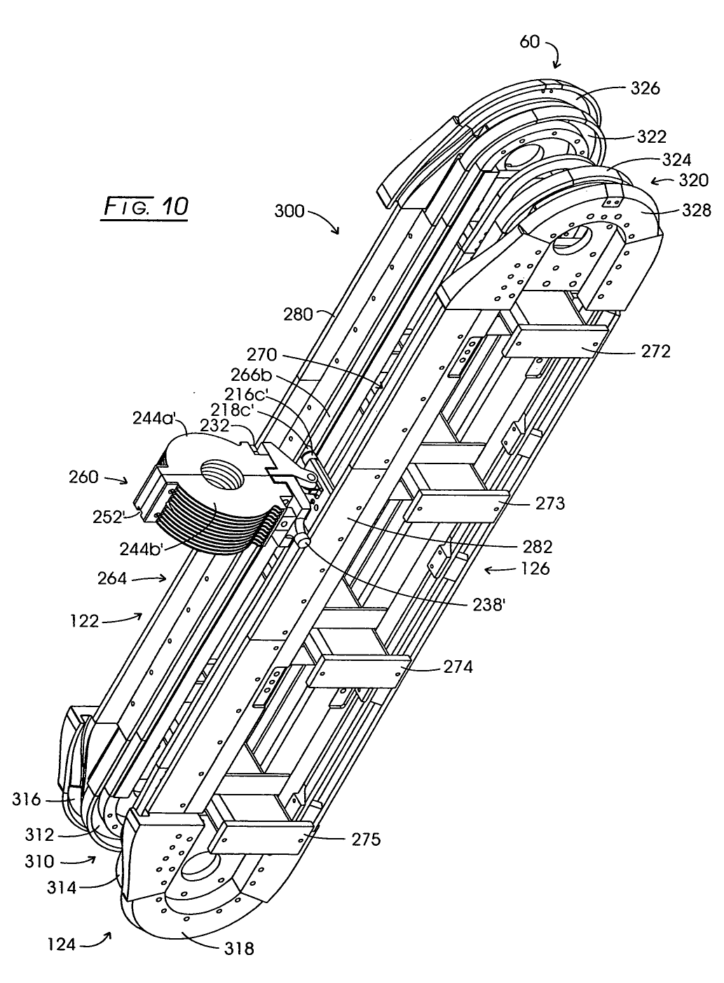

As discussed above in connection with FIG. 4, as the mold halves commence to be closed at upper transition region 60 they will surmount and move over portions of the die 30. Looking to FIG. 11, a sequence of molds within upper transition region 60 as well as tunnel forming region 122 is represented at 340-346. Of these molds, molds 340-343 are within the upper transition region 60 and are commencing to close about the lower region of die 30. Note in that region that the die incorporates three heater bands 348-350 which extend to nozzle 150 from which plastic extrudate 152 is issuing. The elevation of nozzle 150 is above the level of commencement of the forming tunnel represented at level 156. In this regard, nozzle 150 may be located from about 0 inches to about 6 inches above elevation or level 156, about 2 inches being preferred. Note that mold and carriage assembly 343 is closing over nozzle 150 and a portion of the cylindrically shaped plastic material 152 issuing from the annulus shaped nozzle 150. As the mold halves come together a vacuum port as described earlier in connection with FIG. 8 at 252 is formed. Note that the vacuum port will be downwardly oriented such that it will operatively engage the uppermost compartmentalized portion of the vertical vacuum manifold 174. That component of the manifold is provided vacuum from elbow 172f. Mold and carriage assembly 344 is seen passing behind a horizontal support 354 which is another component of the molding assemblage.

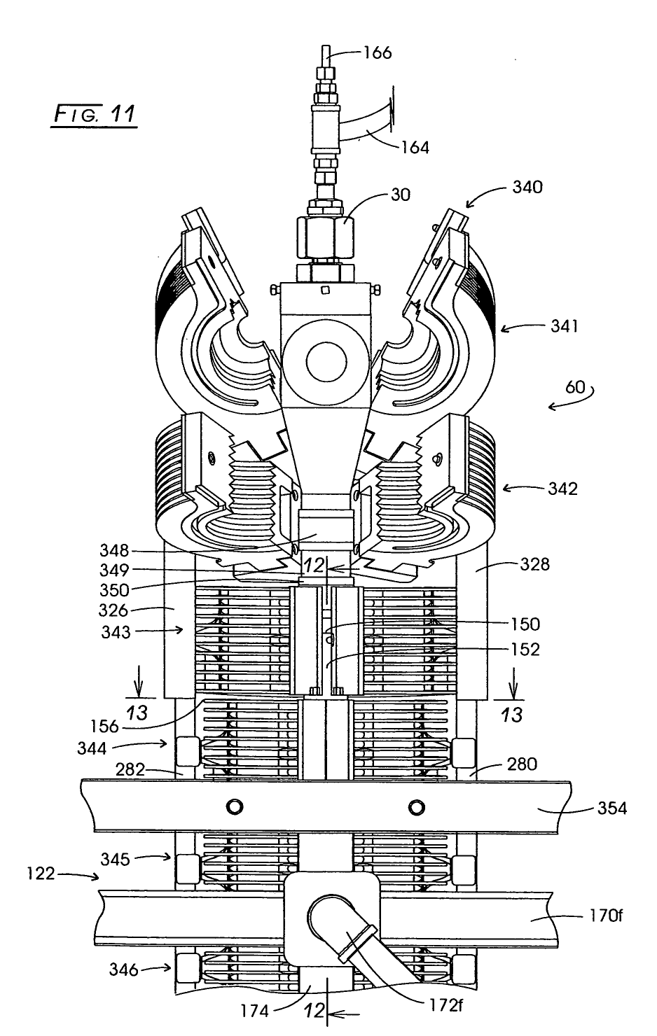

Referring to FIG. 12, mold and carriage assemblies 343-346 reappear in sectional fashion in conjunction with a mold and carriage assembly 347. Note in the figure that mold and carriage assembly 343 is just approaching the entrance level 156 of the forming tunnel region 122. Make-up air from make-up air hose 164 (FIG. 11) will have put a slight internal pressure within the extrudate 152 such that it expands slightly outwardly as it moves downwardly under the additional influence of gravity. As the extrudate reaches level 156 it falls under the vacuum influence of mold 344 by virtue of the vacuum supplied from vacuum manifold upper compartment 356 which is provided vacuum from elbow 172f. Note that the vacuum port 358 of mold 344 is in vacuum association with compartment 356. Thus, vacuum is supplied to the entire mold cavity including the upper portion represented generally at 360. Molds 344-346 within the forming tunnel are forming a part or product represented in general at 362. Part 362 will be one of a sequence of parts, a portion of an identical part being seen at 363 in conjunction with mold 347. The part is, for example, a polymeric boot employed for protective purposes on the undercarriages of automobiles. Note, for instance, that part 362 has a region of maximum diameter or cross dimension as represented in general at 364. However, at location 366 the mold cavity at mold 344 is of much lesser diameter or cross dimension both with respect to region 364 and with respect to the diameter of nozzle 150. By designing the part 362 such that it has an accommodation region or portion of larger diameter or cross dimension as at 368 immediately above and following the constricted region 366, excess buildup of thermoplastic material is avoided.

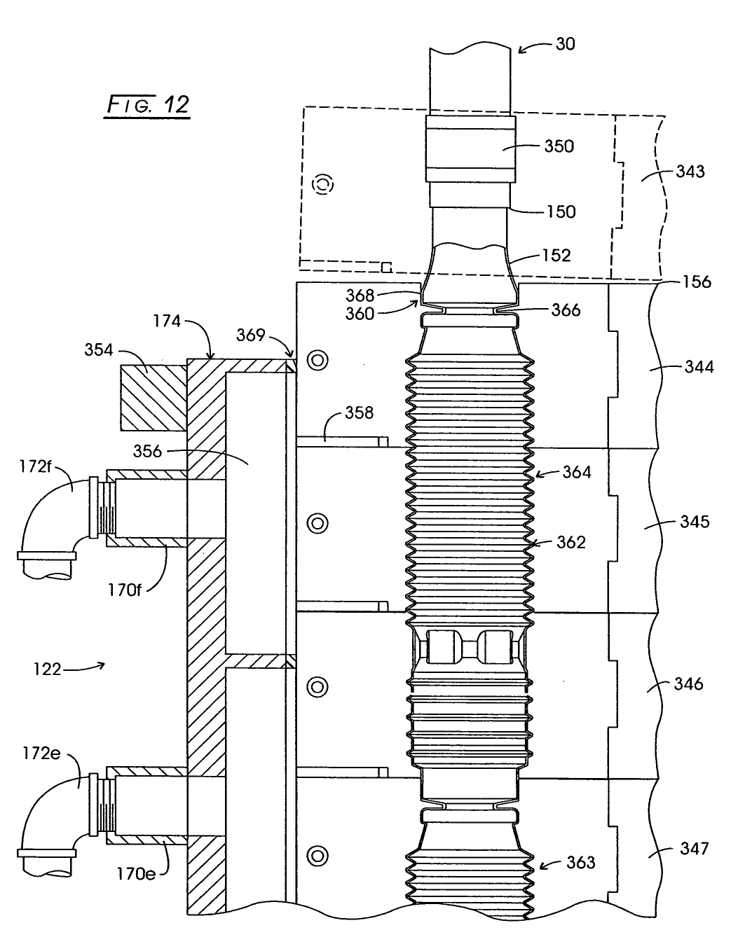

This mold design approach may be employed when the part is formed with a closed end, i.e., a zero cross dimension. An advantage of the wider diameter of nozzle 150 resides in substantial minimization of the stretch ratio exerted on the extrudate particularly with respect to regions as at 364. In general this stretch ratio is less than about 3:2. Region 368 may be designated as an accommodation mold cavity portion. Also seen in FIG. 12 is a polymeric bearing assembly represented generally at 369. Assembly 369 functions to avoid ware along the region of the vacuum ports of the molds. Referring to FIG. 13 the components of mold and carriage assembly 344 include mold halves 370a and 370b which are mounted upon a carriage assembly represented generally at 372. Mold halves 370a and 370b extend to integrally formed extensions 374a, 374b which, when joined together, define vacuum port 358 (FIG. 12). As that vacuum port encounters upper vacuum manifold compartment 356 extensions 374a and 374b are pressed together by oppositely disposed pressing or pinch rolls 376 and 378, supported upon respective brackets 380 and 382 extending, in turn, from horizontal support 354. Rolls 376 and 378 assure that the molds are closed and appropriate vacuum is available throughout the entirety of this uppermost mold within the dynamic forming tunnel.

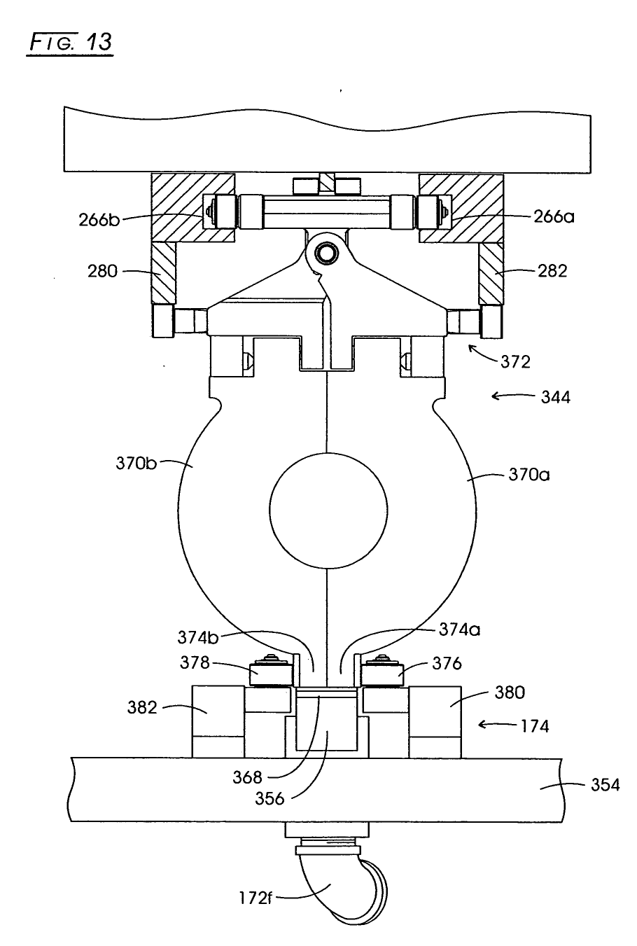

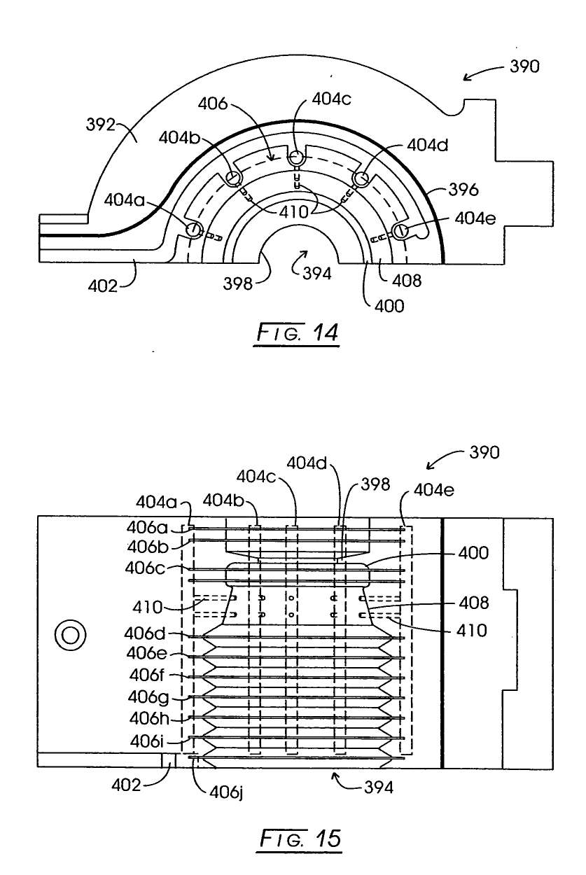

Referring to FIGS. 14 and 15, this vacuum development at the mold cavity is illustrated in conjunction with the earlier-discussed technique of mold cavity structuring such that portions in regions of lesser dynamic extent or cross dimension than the die nozzle 150 can be developed without undesirable extrudate buildup.

FIGS. 14 and 15 illustrate a half mold employed in producing a part as described at 362 in FIG. 12. In this regard, FIG. 14 is a bottom view of the half mold as represented generally at 390. This bottom view shows a smooth mold lower surface 392 surmounting a mold cavity represented generally at 394 and carrying a thin seal 396. As discussed in connection with region 366 in FIG. 12, the mold cavity 394 is configured with a mold cavity portion 398 of smaller or minimum diametric extent or cross dimension which is substantially less than the other mold cavity portions and in particular that next adjacent to it at 400. A vacuum groove 402 is formed in the lower face 392 which communicates vacuum to a sequence of five channels or bores 404a-404e. Bores 404a-404e each communicate with a portion of a sequence of very fine slits seen in phantom at 406. Looking to the side view of mold half 390 in FIG. 15, these slits reappear at 406a-406f. Vacuum is supplied to the non-accordion portion of the mold as at region 408 seen in FIG. 15 by a plurality of thin bores which communicate with bores 404a-404e certain of which are represented at 410.

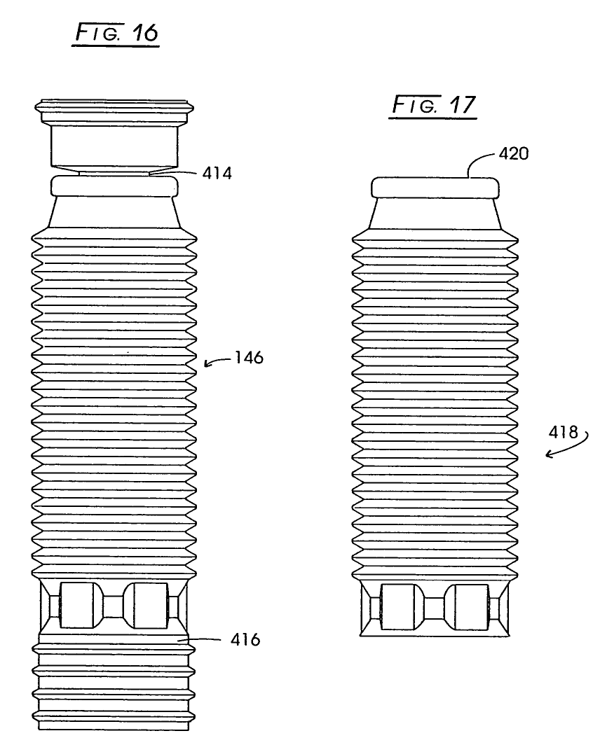

Following exit from the outfeed transition region of the system 10, as described in FIG. 3, a part 146 is created at the guillotine-type cut off station 142. That part 146 is reproduced at an enhanced level of detail in FIG. 16. The region of the part of minimal diametric extent now revealed at region 414 as well as its wider accommodation portion along with the lower region as represented at 416 then are trimmed to evolve the part represented at 418. By forming the region 414 the formation of an opening at 420 is facilitated.

As is apparent from an examination of FIGS. 1-3, the apparatus and system 10 of the invention is relatively large and robust. Accordingly, it enjoys a somewhat inherent configuration flexibility. For instance, as part of this fixed flexibility, the product through-put rate may be increased without a concomitant significant elevation of carriage/mold drive speeds. As another aspect of such flexibility, the system may be employed with a simultaneous utilization of different thermoplastic materials and multiple and different products may be simultaneously molded.

Product through-put for each may be increased by providing two or more product forming cavities within each of the paired mold halves, i.e., multiple forming tunnels are developed.

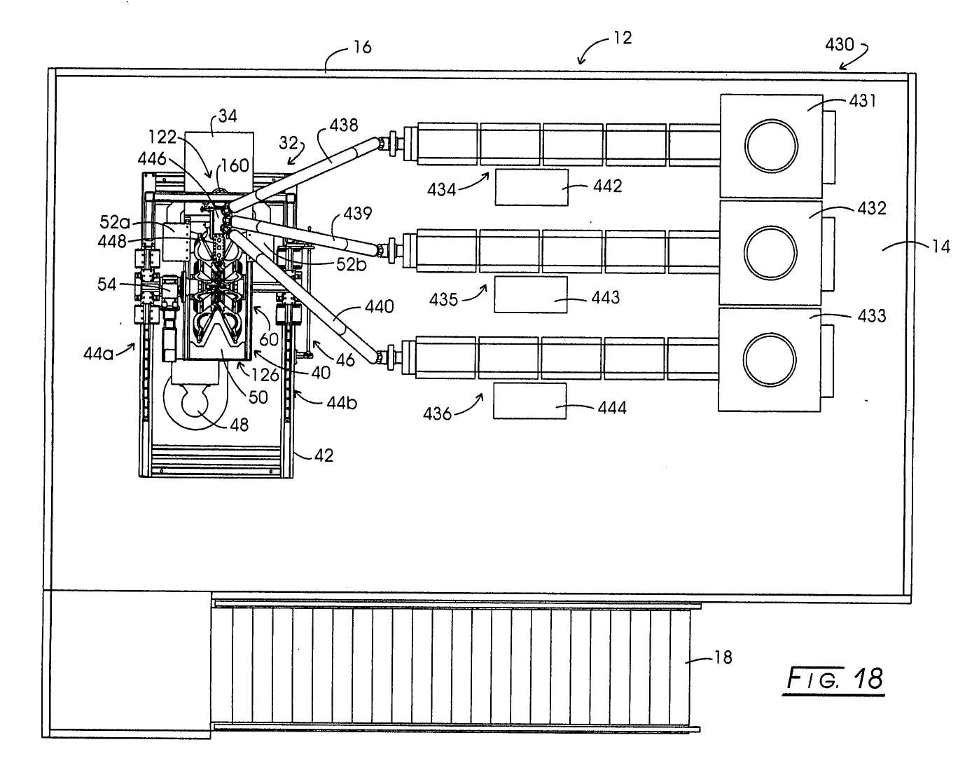

Referring to FIG. 18, such a reconfigured molding system is represented in general at 430. Inasmuch as system 430 incorporates most of the apparatus components heretofore described, where they remain identical, they are identified with the same numeration as provided in the earlier figures. Accordingly, molding system 430 is illustrated looking down upon a platform represented generally at 12 which supports an elevated floor 14 surmounted by a peripherally disposed railing 16. Access to the floor 14 is by a stairway 18.

Now seen mounted upon the floor 14 are three feed hoppers 431433 which are loaded with typically palletized thermoplastic material for introduction to respective heating and pressurization assemblies represented generally at 434-436. Assemblies 434-436, as before, are implemented as elongate, screw activated extruders wherein thermoplastic material is heated and conveyed under pressure to respective distribution tubes 438-440. A plurality of heater bands (not shown) are positioned over the distribution tubes 438-440 to maintain the elasticity of the material being driven through them. Sitting adjacent each of the assemblies 434-436 are housings or boxes shown respectively at 442-444 functioning to retain electrical control equipment.

Distribution tubes 438-440 extend in material conveying relationship to a die assembly or distribution manifold 446 which, in turn, is coupled in material distribution relationship with a multiple nozzle die 448 assembly. The combination of die manifold 446 and die assembly 448 is vertically adjustable and supported from a die support frame represented generally at 32. The earlier-described hand crank utilized for vertical adjustment reappears at 160. An angularly downwardly depending flat shield member is shown at 34 extending outwardly from the die support frame 32. Multiple nozzle die assembly 448 performs in conjunction with a molding assembly represented generally at 40 which extends from a location above the floor 14 of support assembly 12 downwardly though a rectangular opening 42 within the floor 14. Molding assembly 40 is mounted upon a track and carriage system, the upper components of which are seen in the figure at 44a and 44b. This track and carriage system functions to permit the relative movement of the molding assembly 40 with respect to the multiple nozzle die assembly 448 for purposes of reconfiguring the molds or maintenance. Such movement is carried out by manipulation of an elongate crank and screw assembly represented generally at 46. The molding assembly 40, as before, incorporates a track assembly which, in turn, supports and provides manipulation of a plurality of carriages which, in turn, carry mateing mold halves in a manner permitting clam shell performance. For the instant embodiment, those dam shell halves are formed with two or more mold cavities evoking the corresponding development of two or more forming tunnels which operate essentially simultaneously. Additionally mounted upon and moveable with the assembly 40 are cooling duct components and associated blowers. An air blower is observable at 48 which is located below the level of floor 14 and feeds a generally V-shaped duct 50. A similar blower arrangement, duct components of which are seen at 52a and 52b, functions to carry out cooling of the closed molds during their vertical movement along the vertical forming tunnel region 122. A drive assembly incorporating an electric motor and an associated reduction gear box is represented generally at 54 mounted upon and moveable with the assembly 40. Identified in the figure is the introduction or upper transition region represented generally at 60, the vertical forming tunnel region represented generally at 122, and the vertical return region represented generally at 126.

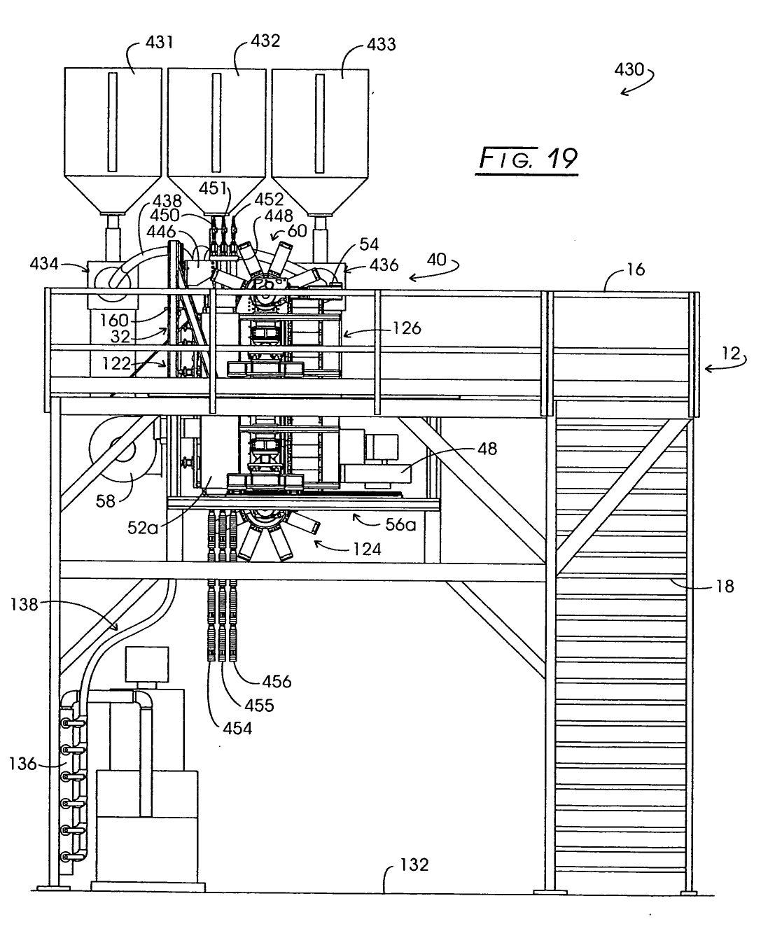

Referring to FIG. 19, a front view of the system 430 is revealed. The figure shows one lower component, 56a of the track and carriage system supporting molding assembly 40. Also located below the floor 14 is an air blower 58 which is moveable with the molding assembly 40 and which functions to feed cooling air to ducts 52a and 52b, duct 52a being seen in the instant figure. In general, the molding assembly 40 incorporates a track assembly which is not seen in this figure but which supports a plurality of mutually abutting carriages in a capture fashion discussed above in connection with FIG. 7-10. Paired molds at forming tunnel location 122 are cooled by the air ducts 52a and 52b. That forming tunnel region extends to an outfeed region again identified in general at 124. From region 124, the track assembly supports open clam shell die halves as they are vertically driven upwardly at the vertical return region 126. Seen in the figure at the introduction portion 60 are three discrete dies 450-452 which are fed from die manifold 446 and associated distribution tubes 438-440. Each of the dies 448-450, as in the case of die 30 shown in FIG. 4 are configured with a low pressure make-up air hose (not shown) and an upwardly disposed tube accommodating any back pressure.

As described in connection with FIG. 2, as the closed die halves extend and move along the forming tunnel region 122, they slidably engage a vertical sequence of six vacuum stages. As described in connection with FIG. 2, the instant figure reveals a vacuum pump assembly generally at 130 and located on the manufacturing floor represented at level 132. Floor 132 also supports the platform 12. Pump assembly 130 provides vacuum via conduit 134 to a vacuum distribution manifold 136 which supplies six discrete vacuum conditions via a flexible hose array represented generally at 138. That hose array also has been described in connection with FIGS. 3 and 5. As the mold halves leave the dynamic forming tunnel at region 122 they are opened to release, for the instant demonstration, three continuous and typically interconnected sequences or strings of plastic products as represented at 454-456.

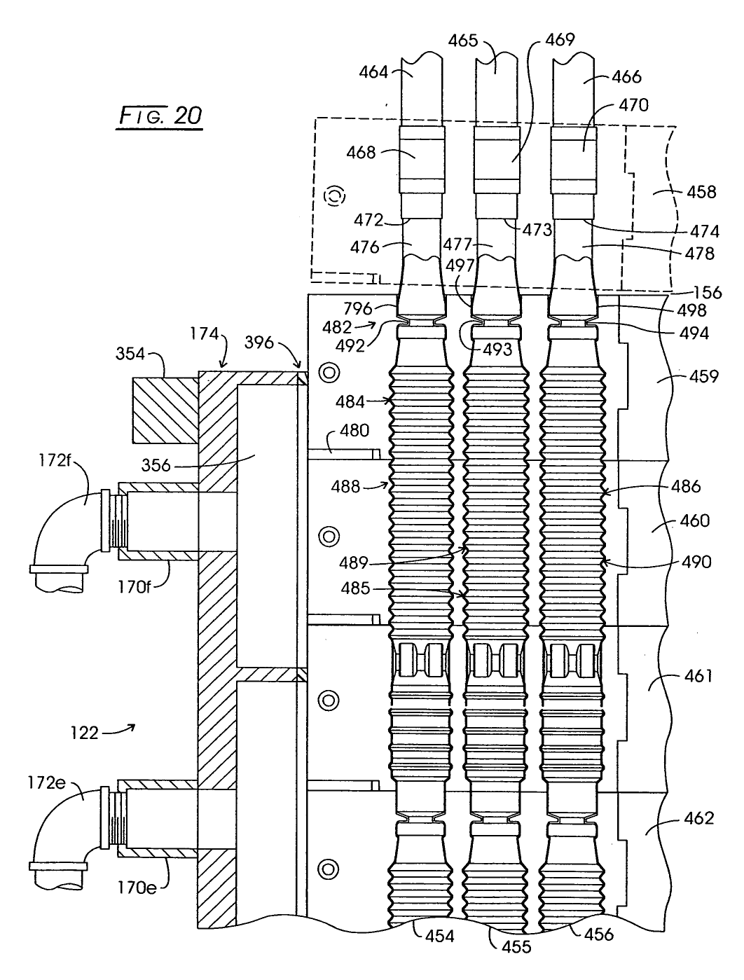

FIG. 20 corresponds with FIG. 12 but with the incorporation of three mold cavities as described in connection with FIGS. 18 and 19. Looking to the figure, a sequence of mold and carriage assemblies 458-462 is represented in sectional fashion. Mold and carriage assembly 458 is just approaching the entrance level 156 of the forming tunnel region 122. Note that the assembly 458 is in the process of closing around or about three discrete nozzle structures 464-466 of respective dies 450-452. The nozzle structures 464-462 are configured with heater bands, three of which are represented respectively at 468-470 and extend to nozzle exits shown respectively at 472-474. Plastic extrudate or parisons are shown issuing from nozzle exits 472-474 as represented respectively at 476-478. As before, the elevation of nozzle exits 472-474 may be located from about 0 inches to about 6 inches above elevation or level 156, about 2 inches being preferred. Make-up air as described in connection with FIG. 11 will have put a slight internal pressure within the parisons 476-478 such that each expands slightly outwardly as it moves downwardly under the additional influence of gravity. As the mold halves come together a vacuum port as described earlier in connection with FIG. 8 at 252 is formed. Note that the vacuum port will be downwardly oriented such that it will operatively engage the uppermost compartmentalized portion of the vertical vacuum manifold 174. That component of the manifold is provided vacuum from elbow 172f. Mold and carriage assembly 459 is seen passing behind horizontal support 354. As the extrudates 476-478 reach level 156 they fall under the vacuum influence of mold 459 by virtue of the vacuum supplied from vacuum manifold upper compartment 356 which is provided vacuum from elbow 172f. Note that the vacuum port 480 of mold 459 is in vacuum association with compartment 356. Thus, vacuum is supplied to the entirety of the three mold cavities including the upper portions as represented generally at 482. For illustrative purposes, the molds as at 459-462 within the molding tunnel are forming three part products simultaneously, for instances, as shown in general at 484-486 which are similar to part 362 described in connection with FIG. 12. Note, for instance, that parts 484-486 exhibit regions of maximum diameter or cross-section as represented respectively at 488-490. However, at respective locations 492-494 the mold cavities at mold 459 are of much lesser diameter or cross dimension both with respect to regions of maximum extent 488-490 and with respect to the diameters of nozzle exits 472-474. By designing part products 484-486 such that they have an accommodation region or portion of larger diameter of cross dimension as at 496-498 immediately above and following the constricted regions 492-494, excess build-up of thermoplastic material is avoided.

As discussed in connection with FIG. 12, this mold design approach may be employed when the parts are formed with a closed end, i.e., a zero cross dimension. An advantage of the wider diameter of the nozzle exits 472-474 resides in a substantial minimization of the stretch ratio exerted on the extrudate particularly with respect to regions of maximum cross-dimensional extent as at 488-490. In general, the stretch ratio again is less than about 3:2. Regions 496-498, as before, may be designated as a combination mold cavity portion. Also seen in the figure is a polymeric bearing assembly represented generally at 369. Assembly 369 functions to avoid wear along the region of the vacuum ports of the molds.

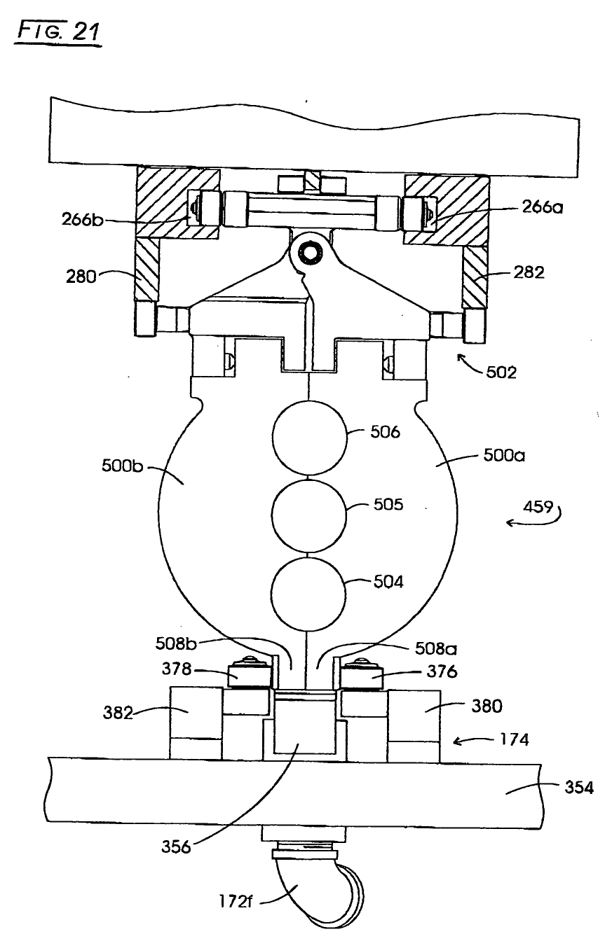

FIG. 21 is an adaptation of earlier-described FIG. 13, such adaptation being that of converting the mold structure to a 3-cavity one in consonance with the discussion associated with FIGS. 18-20. Looking to the figure, the components of the mold and carriage assembly 459 includes mold halves 500a and 500b which are mounted upon a carriage assembly represented generally at 502. Note that, when closed as shown, the mold halves 500a and 500b create three adjacent mold cavities 504-506. These molds are configured with integrally formed extensions 508a, 508b which, when joined together, define vacuum port 480 (FIG. 20). As that vacuum port encounters upper vacuum manifold compartment 356, extensions 508a and 508b are pressed together by oppositely disposed pressing or pinch roles 376 and 378 supported upon respective brackets 380 and 382 extending, in turn, from horizontal support 354. Rolls 376 and 378 assure that the molds are closed and appropriate vacuum is available throughout the entirety of this uppermost mold within the dynamic forming tunnel.

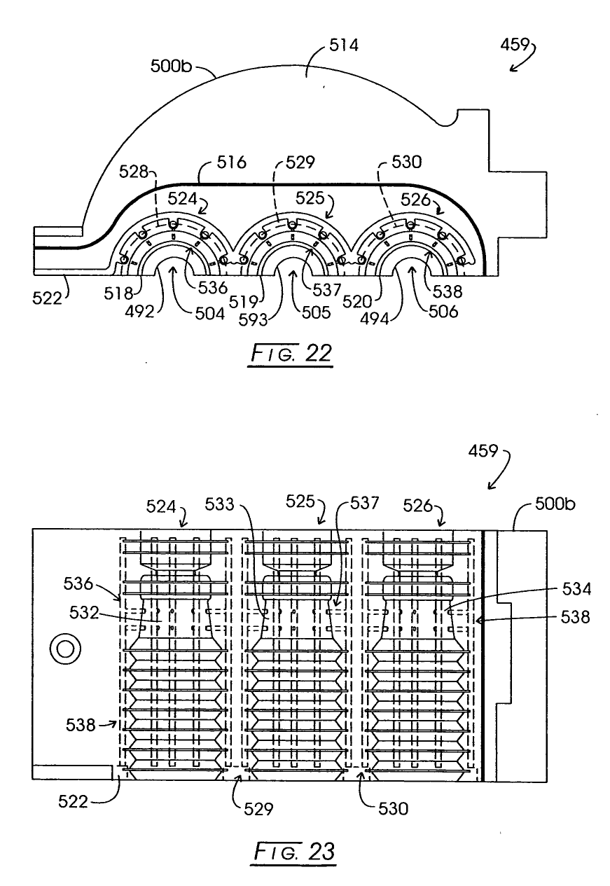

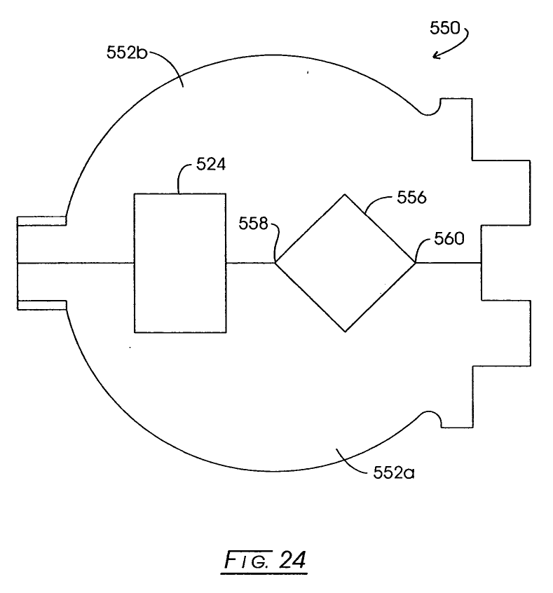

FIGS. 22 and 23 are adaptations of respective FIGS. 14 and 15 showing half mold configurations incorporating the 3-mold cavities 504-506. As in the case of FIGS. 14 and 15, vacuum development at the mold cavities is illustrated. The figures are associated with the earlier-described part products 484-486. FIG. 14 is the bottom view of the half mold 500b as associated with mold and carriage assembly 459 shown in FIG. 20. This bottom view shows a smooth mold lower surface 514 surmounting the earlier-described three mold cavities 504-506 and carrying a thin seal 516. As discussed in connection with regions 492-494 in FIG. 20, the mold cavities 504-506 are configured with mold cavity portions 492-494 of smaller or minimum diametric extent or cross dimension which is substantially less than the other mold cavity portions, for example, as at 518-520. A vacuum groove 522 is formed in the lower face 514 which communicates vacuum to a sequence of 15 channels or bores, five of which surmount each of the cavities 504-506. For example, a bore array shown generally at 524 extends about mold cavity 504; a bore array represented generally at 525 extends about mold cavity 505; and a bore array represented generally at 526 extends about mold cavity 506. Each of the bores of the arrays 524-526 communicate with a portion of a sequence of very fine slits seen in phantom respectively at 528-530. Looking to the side view of mold half 500b in FIG. 23, these arrays of slits reappear with the same general identifying numeration. Vacuum is supplied to the non-accordion portion of the mold as at regions 532-534 (FIG. 23) by pluralities of thin bores. In this regard, an array of thin bores is represented generally at 536 in conjunction with cavity 504; an array of thin bores is represented generally at 537 communicate with the array of bores 525; and an array of thin bores represented generally at 538 communicate with the array of bores 526.

As discussed above, two or more mold cavities may be incorporated within each mold and carriage assembly. Looking to FIG. 24, a mold assembly is represented in general at 550 with mold halves 552a and 552b. Mold halves 552a and 552b cooperate, when closed to provide two mold cavities 554 and 556. Note that each has a rectangular cross-sectional structure, the cross-section of cavity 554 being an elongate rectangle and cavity 556 having a square cross-section, for example, providing a square container. For the arrangement of mold cavity 556, note that the cavity edges as at 558 and 560 are provided at the part line between the clam shell mold halves 552a and 552b. This would place the parting line of a resultant molded product at an edge of a container or other part with the noted cross-sectional configuration.

Implementing the mold structures with two mold cavities maintains the advantage of increasing the mold product through-put rate.

Since certain changes may be made in the above-described system and apparatus without departing from the scope of the invention herein involved, it is intended that all matter contained in the description thereof and shown in the accompanying drawings shall be interpreted as illustrative and not in a limiting sense.

1. Apparatus for carrying out a thermoplastic material molding process, comprising:
a support assembly;
a track assembly supported by said support assembly, having an upper transition region with an uppermost introduction portion transitioning downwardly toward the entrance of a substantially vertical forming tunnel region with a forming tunnel support portion, such forming tunnel region extending to an outfeed transition region with an outfeed portion, and a return region with a return portion extending from said outfeed transition region to said upper transition region;
a plurality of carriage assemblies movable along said track assembly in a mutually abutting orientation each having a pivotally paired wing assembly movable between mold open and mold closed orientations;
a plurality of paired mold halves, each mold half having a mold half cavity, each such paired mold halves being supported upon an associated said paired wing assembly to provide, when said paired wing assemblies are in said mold closed orientation, a molding sequence of carriage supported mold cavities defining at least a portion of the profiles of one or more products;
a drive assembly configured to generally continuously move said plurality of carriage assemblies along a single track locus about said track assembly and to effect said pivotal movement of each said wing assembly from said mold open orientation toward said mold closed orientation along said introduction portion and to effect actuation into said mold closed orientation at the entrance of said forming tunnel support portion to define a dynamic forming tunnel extending from a tunnel entrance toward said outfeed portion; and
an extruder assembly configured to receive and thermally treat said thermoplastic material and having an extruder nozzle with a nozzle opening located to express extrudate downwardly toward said dynamic forming tunnel entrance.

2. The apparatus of claim 1 in which:
said extruder nozzle opening is located above said dynamic forming tunnel entrance a distance from about 0 inches to about 6 inches.

3. The apparatus of claim 2 in which:
said extruder nozzle opening is located above said dynamic forming tunnel entrance a distance of about 2 inches.

4. The apparatus of claim 1 in which:
each said half mold is configured with vacuum passages extending between an associated mold cavity and, when in said mold closed orientation, an outwardly disposed vacuum port;
further comprising:
a source of vacuum; and
a generally vertically oriented vacuum manifold supported at said support assembly, coupled in vacuum transfer relationship with said source of vacuum and having a manifold vacuum port assembly extending generally vertically adjacent said dynamic forming tunnel from said tunnel entrance toward said outfeed portion and engageable in vacuum transfer relationship with the outwardly disposed vacuum ports of said paired half molds disposed along said forming tunnel region.

5. The apparatus of claim 1 in which:
each said half mold is formed having an outwardly disposed heat exchange surface;
further comprising:
an airflow assembly having one or more airflow outlets directing an airflow over the said outwardly disposed heat exchange surface of each said half mold when located substantially along said forming tunnel.

6. The apparatus of claim 1 in which:
said track assembly and drive assembly are configured to maneuver each said wing assembly toward said mold open orientation in the vicinity of said outfeed portion and to retain said mold open orientation when said carriage assemblies are moved along at least a portion of said track assembly return region; and
further comprising:
an airflow assembly having one or more airflow outlets directing an airflow over the said mold half cavities exposed when an associated said paired wing assembly has been actuated into said mold open orientation.

7. The apparatus of claim 6 in which:
said airflow assembly airflow outlets are located to direct said airflow onto said mold half cavities when an associated said paired wing assembly is within said track assembly return region.

8. The apparatus of claim 1 in which:
each said carriage assembly paired wing assembly comprises two pivotally coupled wing members pivotally movable between said mold open and mold closed orientations to define a clamshell performance.

9. The apparatus of claim 1 in which:
two or more said paired mold halves and associated paired wing assemblies are located in a sequence with paired mold cavities defining one said product.

10. The apparatus of claim 9 in which:
one of said paired mold halves is configured having corresponding paired mold cavities defining a said product with a closed end.

11. The apparatus of claim 1 in which:
one or more said mold cavities exhibit a mold cavity portion of maximum diameter or cross dimension; and
said extruder assembly is configured having an annular said nozzle opening exhibiting a nozzle diameter corresponding with but less than said mold cavity portion of maximum diameter or cross dimension.

12. The apparatus of claim 11 in which:
said nozzle diameter is effective to substantially minimize the stretch ratio asserted upon said extrudate to effect movement thereof into product defining position within said mold cavity portion of maximum diameter or cross dimension.

13. The apparatus of claim 12 in which:
said stretch ratio is less than about 3:2.

14. The apparatus of claim 11 in which:
a given said mold cavity exhibits a mold cavity portion of zero to minimum diametric extent or cross dimension substantially less than said mold cavity portion of maximum diameter or cross dimension at a given position within said mold sequence; and
said given mold cavity is configured having an accommodation mold cavity portion of accommodation diametric extent or cross dimension greater than said minimum diametric extent or cross dimension positioned above and next adjacent said mold cavity portion of minimum diametric extent or cross dimension when said given mold cavity is a component of said defined dynamic forming tunnel.

15. The apparatus of claim 1 in which:
said extruder assembly further comprises a make-up air input coupled with a source of air under low pressure and having a downwardly directed make-up air outlet with an airflow disposed centrally of said nozzle opening and a generally upwardly directed vent configured for releasing any excessive air backpressure at said airflow.

16. The apparatus of claim 15 in which:
said low pressure is from about 3 psi to about 5 psi.

17. The apparatus of claim 1 in which:
those carriage and mold assemblies within a sequence thereof at said forming tunnel region are in freely abutting gravitationally enhanced mutual contact.

18. The apparatus of claim 1 further comprising:
a mold pinching station supported from said support assembly adjacent said entrance of said forming tunnel region and configured to compressively urge said paired mold halves together at the commencement of said forming tunnel.

19. A system for forming product from thermoplastic material, comprising:
a heating and pressurization assembly deriving a source of heated thermoplastic material under pressure;
a sequence of paired, mutually pivotally connected mold halves movable between an open orientation and a closed orientation deriving a closed mold cavity defining at least a portion of a said product, and configured to provide an outwardly disposed vacuum port in vacuum communication with vacuum mold conduits extending into said mold cavity;
a mold support and drive assembly actuable to move said sequence of paired mold halves along a single track locus having an upper transition region thence downwardly when in said closed orientation along a substantially vertical locus defining a forming tunnel extending from a tunnel entrance elevation to a tunnel exit at an exit location below said entrance location, thence along an outfeed transition region wherein said mold halves are moved toward said open orientation;
a die assembly coupled in material transfer relationship with said heating and pressurization assembly and having a downwardly depending extrusion nozzle located to express extrudate downwardly into said forming tunnel from an elevation at or above said tunnel entrance elevation; and
a vacuum assembly configured to effect application of vacuum to each said vacuum port along said vertical locus.

20. The system of claim 19 in which:
said extrusion nozzle is located at an elevation above said tunnel entrance elevation within a range of about 0 inches to about six inches.

21. The system of claim 20 in which:
said extrusion nozzle is located about 2 inches above said tunnel entrance elevation.

22. The system of claim 19 in which:
the paired mold halves of each said mold half assembly are pivotally movable to define a clamshell mold.

23. The system of claim 19 in which:
said mold support and drive assembly is configured to move said sequence of paired mold halves from said outfeed transition region along a substantially vertical single track locus defining a return region and extending upwardly to said upper transition region while said paired mold halves are moved toward or are in said open orientation.

24. The system of claim 23 further comprising:
a return airflow assembly having one or more generally v-shaped vertically disposed air ducts with airflow outlets directing an air flow over the cavities of said mold halves along at least a portion of said return region.

25. The system of claim 19 in which:
each said mold half is formed having an outwardly disposed heat exchange surface; and
further comprising:
an airflow assembly having one or more airflow outlets directing an airflow over the said outwardly disposed heat exchange surface.

26. The system of claim 19 in which said vacuum assembly comprises:
a source of vacuum;
a generally vertically oriented compartment vacuum manifold coupled in vacuum transfer relationship with said source of vacuum and having a manifold vacuum port assembly extending generally vertically adjacent said forming tunnel and slidably engageable in vacuum transfer relationship with the said outwardly disposed vacuum port of each said paired mold when defining said forming tunnel.

27. The system of claim 19 in which:
one or more said closed mold cavities exhibit a mold cavity portion of maximum diametric extent or cross dimension; and
said die assembly extrusion nozzle is configured with an annulus-shaped opening exhibiting a nozzle diametric extent corresponding with but less than said mold cavity portion of maximum diametric extent or cross dimension.

28. The system of claim 27 in which:
said nozzle diametric extent is effective to substantially minimize the stretch ratio asserted upon said extrudate to effect movement thereof into part defining position within said mold cavity portion of maximum diametric extent or cross dimension.

29. The system of claim 28 in which:
said stretch ratio is less than about 3:2.

30. The system of claim 29 in which:
a given said mold cavity exhibits a mold cavity portion of zero to a minimum diametric extent or cross dimension substantially less than said mold cavity portion of maximum diametric extent or cross dimension at a given position within said sequence of paired mold halves; and
said given mold cavity is configured having an accommodation mold cavity portion of accommodation diametric extent or cross dimension greater than said zero to a minimum diametric extent or cross dimension positioned above and next adjacent said mold cavity portion of zero to minimum diametric extent.

31. The system of claim 19 in which:
said die assembly further comprises a make-up gas input coupled with a source of gas under low pressure and having a downwardly directed make-up gas outlet with a gas flow disposed centrally of said extrusion nozzle and a generally upwardly directed vent configured for releasing any excessive gas backpressure at said gas flow.

32. The system of claim 31 in which:
said gas is air and said low pressure is from about 3 psi to about 5 psi.

33. The system of claim 19 in which:
said paired mold halves, when in said closed orientation at said vertical locus defining a forming tunnel, are in freely abutting gravitationally enhanced mutual contact.

34. The system of claim 19 further comprising:
a mold pinching station located adjacent said tunnel entrance elevation configured for compressively urging said paired mold halves together at the commencement of said forming tunnel.

35. A system for carrying out a thermoplastic material molding process, comprising:
a support assembly;
a heating and pressurization assembly deriving a source of heated thermoplastic material under pressure;
a sequence of paired mold half assemblies pivotally coupled to define a clamshell mold configuration movable between an open orientation and a closed orientation deriving a closed mold cavity corresponding with at least a portion of a product, each said paired mold half assembly, when in said closed orientation exhibiting a mold cavity portion of maximum diametric extent or cross dimension, having a vacuum port in vacuum communication with vacuum mold conduits extending within said mold cavity and having an exterior paired mold surface;
a mold support and drive assembly mounted upon said support assembly actuateable to move said sequence of paired mold halves along a single track locus having an upper transition region, thence downwardly while in said closed orientation along a substantially vertical single track locus defining a forming tunnel extending from a tunnel entrance elevation to a tunnel exit at an exit location below said entrance location, thence along an outfeed transition region wherein said mold halves are maneuvered into said open orientation to outwardly expose the mold half cavities thereof with a generally v-shaped configuration, thence upwardly while in said open orientation along a substantially vertical single track return locus into said upper transition region;
a die assembly mounted upon said support assembly in material transfer relationship with said heating and pressurization assembly and having a downwardly depending extrusion nozzle of nozzle diametric extent corresponding with but less than said mold cavity portion of maximum diametric extent or cross dimension and located to express extrudate downwardly into said forming tunnel from an elevation at or above said tunnel entrance elevation;
a vacuum assembly having a vertically disposed vacuum manifold supported by said support assembly along said forming tunnel in vacuum asserting communication with the vacuum ports of mold half assemblies thereat; and
a tunnel air cooling assembly having one or more cooling air outlets supported by said support assembly disposed vertically adjacent said forming tunnel and oriented to blow air over the exterior paired mold surface of mold half assemblies thereat.

36. The system of claim 35 further comprising:
a return airflow assembly supported by said support assembly having one or more vertically disposed generally v-shaped air ducts with airflow outlets directing an airflow over the outwardly exposed mold half cavities while moved along said return locus toward said upper transition region.

37. The system of claim 35 in which:
said nozzle diameter is effective to substantially minimize the stretch ratio asserted upon said extrudate to effect movement thereof into product defining position within said mold cavity portion of maximum diametric extent or cross dimension.

38. The system of claim 37 in which:
said stretch ratio is less than about 3;2.

39. The system of claim 37 in which:
a given said mold cavity exhibits a mold cavity portion of zero to minimum diametric extent or cross dimension substantially less than said mold cavity portion of maximum diameter or cross dimension at a given position within said mold sequence; and
said given mold cavity is configured having an accommodation mold cavity portion of accommodation diametric extent or cross dimension greater than said minimum diametric extent or cross dimension positioned above and next adjacent said mold cavity portion of minimum diametric extent or cross dimension when said given mold cavity is a component of said defined forming tunnel.

40. Apparatus for carrying out a thermoplastic material molding process, comprising:
a support assembly;
a track assembly supported by said support assembly, having an upper transition region with an uppermost introduction portion transitioning downwardly toward the entrance of a substantially vertical forming tunnel region with a forming tunnel support portion, such forming tunnel region extending to an outfeed transition region with an outfeed portion, and a return region with a return portion extending from said outfeed transition region to said upper transition region;
a plurality of carriage assemblies movable along said track assembly in a mutually abutting orientation each having a pivotally paired wing assembly movable between mold open and mold closed orientations;
a plurality of paired mold halves, each mold half having two or more mold half cavities, each such paired mold halves being supported upon an associated said paired wing assembly to provide, when said paired wing assemblies are in said mold closed orientation, two or more molding sequences of carriage supported mold cavities defining at least a portion of the profiles of one or more products;
a drive assembly configured to generally continuously move said plurality of carriage assemblies along a single track locus about said track assembly and to effect said pivotal movement of each said wing assembly from said mold open orientation toward said mold closed orientation along said introduction portion and to effect actuation into said mold closed orientation at the entrance of said forming tunnel support portion to define two or more dynamic forming tunnels each extending from a tunnel entrance toward said outfeed portion; and
an extruder assembly configured to receive and thermally treat said thermoplastic material and having two or more extruder nozzles, each with a nozzle opening located to express extrudate downwardly toward an associated said dynamic forming tunnel entrance.

41. The apparatus of claim 40 in which:
each said extruder nozzle opening is located above an associated said dynamic forming tunnel entrance a distance from about 0 inches to about 6 inches.

42. The apparatus of claim 41 in which:
each said extruder nozzle opening is located above an associated said dynamic forming tunnel entrance a distance of about 2 inches.

43. The apparatus of claim 40 in which:
each said half mold is configured with vacuum passages extending between said two or more mold cavities and, when in said mold closed orientation, an outwardly disposed vacuum port;
further comprising:
a source of vacuum; and
a generally vertically oriented vacuum manifold supported at said support assembly, coupled in vacuum transfer relationship with said source of vacuum and having a manifold vacuum port assembly extending generally vertically adjacent said two or more dynamic forming tunnels from each said tunnel entrance toward said outfeed portion and engageable in vacuum transfer relationship with the outwardly disposed vacuum ports of said paired half molds disposed along said forming tunnel region.

44. The apparatus of claim 40 in which:
each said half mold is formed having an outwardly disposed heat exchange surface; and
further comprising:
an airflow assembly having one or more airflow outlets directing an airflow over the said outwardly disposed heat exchange surface of each said half mold when located substantially along said forming tunnel.

45. The apparatus of claim 40 in which:
said track assembly and drive assembly are configured to maneuver each said wing assembly toward said mold open orientation in the vicinity of said outfeed portion and to retain said mold open orientation when said carriage assemblies are moved along at least a portion of said track assembly return region; and
further comprising:
an airflow assembly having one or more airflow outlets directing an airflow over the said mold half cavities exposed when an associated said paired wing assembly has been actuated into said mold open orientation.

46. The apparatus of claim 45 in which:
said airflow assembly airflow outlets are located to direct said airflow onto said mold half cavities when an associated said paired wing assembly is within said track assembly return region.

47. The apparatus of claim 40 in which:
each said carriage assembly paired wing assembly comprises two pivotally coupled wing members pivotally movable between said mold open and mold closed orientations to define a clamshell performance.

48. The apparatus of claim 1 in which:
two or more said paired mold halves and associated paired wing assemblies are located in a sequence with two or more paired mold cavities defining corresponding two or more said products.

49. The apparatus of claim 48 in which:
one of said paired mold halves is configured having corresponding two or more paired mold cavities defining at least one said product with a closed end.

50. The apparatus of claim 40 in which:
one or more said mold cavities exhibit a mold cavity portion of maximum diameter or cross dimension; and
said extruder assembly is configured having an associated annular said nozzle opening exhibiting a nozzle diameter corresponding with but less than said mold cavity portion of maximum diameter or cross dimension.

51. The apparatus of claim 50 in which:
said nozzle diameter is effective to substantially minimize the stretch ratio asserted upon said extrudate to effect movement thereof into product defining position within a said mold cavity portion of maximum diameter or cross dimension.

52. The apparatus of claim 51 in which:
said stretch ratio is less than about 3:2.

53. The apparatus of claim 50 in which:
a given said mold cavity exhibits a mold cavity portion of zero to minimum diametric extent or cross dimension substantially less than said mold cavity portion of maximum diameter or cross dimension at a given position within said mold sequence; and
said given mold cavity is configured having an accommodation mold cavity portion of accommodation diametric extent or cross dimension greater than said minimum diametric extent or cross dimension positioned above and next adjacent said mold cavity portion of minimum diametric extent or cross dimension when said given mold cavity is a component of said defined dynamic forming tunnel.

54. The apparatus of claim 40 in which:
said extruder assembly for each extruder nozzle, further comprises a make-up air input coupled with a source of air under low pressure and having a downwardly directed make-up air outlet with an airflow disposed centrally of said nozzle opening and a generally upwardly directed vent configured for releasing any excessive air backpressure at said airflow.

55. The apparatus of claim 54 in which:
said low pressure is from about 3 psi to about 5 psi.

56. The apparatus of claim 40 further comprising:
a mold pinching station supported from said support assembly adjacent said entrance of said forming tunnel region and configured to compressively urge said paired mold halves together at the commencement of said forming tunnel.

57. A system for forming product from thermoplastic material, comprising:
a heating and pressurization assembly deriving one or more sources of heated thermoplastic material under pressure;
a sequence of paired, mutually pivotally connected mold halves each movable between an open orientation and a closed orientation deriving two or more closed mold cavities, each defining at least a portion of a said product, and each being configured to provide an outwardly disposed vacuum port in vacuum communication with vacuum mold conduits extending to said mold cavity;
a mold support and drive assembly actuable to move said sequence of paired mold halves along a single track locus having an upper transition region thence downwardly when in said closed orientation along a substantially vertical locus defining two or more forming tunnels, each extending from a tunnel entrance elevation to a tunnel exit at an exit location below said entrance location, thence along an outfeed transition region wherein said mold halves are moved toward said open orientation;
a die assembly coupled in material transfer relationship with said heating and pressurization assembly and having two or more downwardly depending extrusion nozzles, each located to express extrudate downwardly into an associated forming tunnel from an elevation at or above said tunnel entrance elevation; and
a vacuum assembly configured to effect application of vacuum to each said vacuum port along said vertical locus.

58. The system of claim 57 in which:
each said extrusion nozzle is located at an elevation above said tunnel entrance elevation within a range of about 0 inches to about six inches.

59. The system of claim 58 in which:
said extrusion nozzle is located about 2 inches above said tunnel entrance elevation.

60. The system of claim 57 in which:
the paired mold halves of each said mold half assembly are pivotally movable to define a clamshell mold.

61. The system of claim 57 in which:
said mold support and drive assembly is configured to move said sequence of paired mold halves from said outfeed transition region along a substantially vertical single track locus defining a return region and extending upwardly to said upper transition region while said paired mold halves are moved toward or are in said open orientation.

62. The system of claim 61 further comprising:
a return airflow assembly having one or more generally v-shaped vertically disposed air ducts with airflow outlets directing an air flow over the cavities of said mold halves along at least a portion of said return region.

63. The system of claim 57 in which:
each said mold half is formed having an outwardly disposed heat exchange surface; and
further comprising:
an airflow assembly having one or more airflow outlets directing an airflow over the said outwardly disposed heat exchange surface.

64. The system of claim 57 in which said vacuum assembly comprises:
a source of vacuum;
a generally vertically oriented compartment vacuum manifold coupled in vacuum transfer relationship with said source of vacuum and having a manifold vacuum port assembly extending generally vertically adjacent said forming tunnels and slidably engageable in vacuum transfer relationship with the said outwardly disposed vacuum port of each said paired mold when defining said forming tunnels.

65. The system of claim 57 in which:
one or more said closed mold cavities exhibit a mold cavity portion of maximum diametric extent or cross dimension; and
said die assembly extrusion nozzle associated with said mold cavity of maximum diametric extent or cross dimension is configured with an annulus-shaped opening exhibiting a nozzle diametric extent corresponding with but less than said mold cavity portion of maximum diametric extent or cross dimension.

66. The system of claim 65 in which:
said nozzle diametric extent is effective to substantially minimize the stretch ratio asserted upon said extrudate to effect movement thereof into part defining position within said mold cavity portion of maximum diametric extent or cross dimension.

67. The system of claim 66 in which:
said stretch ratio is less than about 3:2.

68. The system of claim 67 in which:
a given said mold cavity exhibits a mold cavity portion of zero to a minimum diametric extent or cross dimension substantially less than said mold cavity portion of maximum diametric extent or cross dimension at a given position within said sequence of paired mold halves; and
said given mold cavity is configured having an accommodation mold cavity portion of accommodation diametric extent or cross dimension greater than said zero to a minimum diametric extent or cross dimension positioned above and next adjacent said mold cavity portion of zero to minimum diametric extent.

69. The system of claim 57 in which:
said die assembly further comprises a make-up gas input coupled with a source of gas under low pressure and having a downwardly directed make-up gas outlet with a gas flow disposed centrally of each said extrusion nozzle and a generally upwardly directed vent configured for releasing any excessive gas backpressure at said gas flow.

70. The system of claim 69 in which:
said gas is air and said low pressure is from about 3 psi to about 5 psi.

71. The system of claim 57 further comprising:
a mold pinching station located adjacent said tunnel entrance elevation configured for compressively urging said paired mold halves together at the commencement of said forming tunnels.

72. A system for carrying out a thermoplastic material molding process, comprising:
a support assembly;
a heating and pressurization assembly deriving one or more sources of heated thermoplastic material under pressure;
a sequence of paired mold half assemblies pivotally coupled to define a clamshell mold configuration movable between an open orientation and a closed orientation deriving two or more closed mold cavities, each corresponding with at least a portion of a product, each said paired mold half assembly, when in said closed orientation exhibiting two or more mold cavity portions of maximum diametric extent or cross dimension, each having a vacuum port in vacuum communication with vacuum mold conduits extending to each said mold cavity and having an exterior paired mold surface;
a mold support and drive assembly mounted upon said support assembly actuateable to move said sequence of paired mold halves along a single track locus having an upper transition region, thence downwardly while in said closed orientation along a substantially vertical single track locus defining two or more forming tunnels each extending from a tunnel entrance elevation to a tunnel exit at an exit location below said entrance location, thence along an outfeed transition region wherein said mold halves are maneuvered into said open orientation to outwardly expose the mold half cavities thereof with a generally v-shaped configuration, thence upwardly while in said open orientation along a substantially vertical single track return locus into said upper transition region;
a die assembly mounted upon said support assembly in material transfer relationship with said heating and pressurization assembly and having two or more downwardly depending extrusion nozzles, each of nozzle diametric extent corresponding with but less than the associated said mold cavity portion of maximum diametric extent or cross dimension and located to express extrudate downwardly into the associated said forming tunnel from an elevation at or above said tunnel entrance elevation;
a vacuum assembly having a vertically disposed vacuum manifold supported by said support assembly along said forming tunnels in vacuum asserting communication with the vacuum ports of mold half assemblies thereat; and
a tunnel region air cooling assembly having one or more cooling air outlets supported by said support assembly disposed vertically adjacent said forming tunnels and oriented to blow air over the exterior paired mold surface of mold half assemblies thereat.

73. The system of claim 72 further comprising:
a return airflow assembly supported by said support assembly having one or more vertically disposed generally v-shaped air ducts with airflow outlets directing an airflow over the outwardly exposed mold half cavities while moved along said return locus toward said upper transition region.

74. The system of claim 72 in which:
each said nozzle diameter is effective to substantially minimize the stretch ratio asserted upon said extrudate to effect movement thereof into product defining position within a said mold cavity portion of maximum diametric extent or cross dimension.

75. The system of claim 74 in which:
said stretch ratio is less than about 3;2.

76. The system of claim 74 in which:
a given said mold cavity exhibits a mold cavity portion of zero to minimum diametric extent or cross dimension substantially less than the corresponding said mold cavity portion of maximum diameter or cross dimension at a given position within said mold sequence; and
said given mold cavity is configured having an accommodation mold cavity portion of accommodation diametric extent or cross dimension greater than said minimum diametric extent or cross dimension positioned above and next adjacent said mold cavity portion of minimum diametric extent or cross dimension when said given mold cavity is a component of said defined forming tunnel.
